(19) United States
(12) Patent Application Publication
(10) Pub. No.: US 2026/0034887 A1
(43) Pub. Date: Feb. 5, 2026

(54) Composite-Structured Lightweight Semi-truck and tractor-Trailer Energy System with artificial intelligence -Enabled Blockchain V2G, Range Extension, and Geo-Fenced Advertising

(71) Applicant: Andre Watts, Atlanta, GA (US)

(72) Inventor: Andre Watts, Atlanta, GA (US)

(21) Appl. No.: 19/268,076

(22) Filed: Jul. 14, 2025

Related U.S. Application Data
(60) Provisional application No. 63/677,104, filed on Jul. 30, 2024.
(60) Provisional application No. 63/677,094, filed on Jul. 30, 2024.

(51) Int. Cl. B60L 1/00; B33Y 80/00; B60L 55/00; G06Q 30/0251; H02K 35/06; H04L 9/00; H04L 9/08

(52) U.S. Cl. CPC B60L 1/00; B60L 55/00; G06Q 30/0266; H02K 35/06; H04L 9/0872; H04L 9/50; B33Y 80/00; B60L 2200/28; B60L 2200/36; B60L 2260/44

(57) ABSTRACT

A structured semi-truck and tractor-trailer system a lightweight composite-structured frame molded from advanced two dimensional polyarylene 2DPA-1 (from a family of aromatic-backbone polymers, of which this is one specialty member) and carbon nano-lattice with nitrogen, integrating a renewable energy node that combines high-efficiency solar films, axial-flux generators, structural battery elements, and graphene-enhanced supercapacitors, yielding many kilowatt-hours per day 400-600 kWh/day and scalable beyond 1,000 kWh/day with tandem configurations. An onboard artificial intelligence (“AI”) engine optimizes energy flows, predicts vehicle and grid demand, and manages a blockchain-enabled smart-contract vehicle-to-grid (“V2G”) sell-back platform. The 2DPA-1 also works with carbon nano-lattice polymers in regards to 3 dimensional lattice structures. A geo-fenced electroluminescent display array provides dynamic, location-targeted advertising. The system extends driving range, reduces grid load, strengthens resilience through bidirectional energy exchange, and generates ancillary revenue-all while preserving trailer aerodynamics and payload capacity.

### FIELD OF THE INVENTION

Composite-Structured Lightweight Semi-truck and tractor-Trailer Energy System with artificial intelligence-Enabled Blockchain V2G, Range Extension, and Geo-Fenced Advertising.

### BACKGROUND

The background description includes information that may be useful in understanding the present invention. It is not an admission that any of the information provided herein is prior art or relevant to the presently claimed invention, or that any publication specifically or implicitly referenced is prior art.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply. The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients or properties such as concentration, reaction conditions, and so forth, used to describe and claim certain embodiments of the invention are to be understood as being modified in some instances by the term “about.”

Accordingly, in some embodiments, the numerical parameters set forth in the written description and attached claims are approximations that can vary depending upon the desired properties sought to be obtained by a particular embodiment.

In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable.

The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meanings of “a,” “an,” and “the” include plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed.

No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

People around the world are using more and more electricity. The power grid will be overstressed due to a higher load from electric cars, data centers and additional electricity use. Currently on a cross-country trip, an electric vehicle would have to charge 8-10 times or more. Blackouts are becoming more common across the United States, and numerous other countries are using more electricity as well. Coal is incredibly polluting, and so a cleaner form of energy generation is needed.

Due to climate change, the world is increasing in heat, and so people are running their air conditioners more, causing a further increase in electricity use. Each year there is record breaking heat around the world.

The rise of just in time delivery companies means increased shipping on semi-trucks and tractor-trailers, which are heavy and burn huge amounts of fuel if running on gas or diesel. They are also polluting, and force dependency on new sources of oil. Due to increased tariffs on solar panels from China, the world's largest maker of solar panels, an alternative to the solar panels produced in China would be useful. Therefore, the world has a need for more electricity, lighter vehicles and different solar power.

### SUMMARY

The present invention increases self-sufficiency by not demanding from the grid, but instead providing power back to the grid. The costs of moving goods will drop drastically when using electricity. The necessity to charge will drop drastically for all vehicles. On a cross-country trip with the present invention, only 2-3 charges may be necessary.

The present invention relates to sustainable energy systems for transportation, specifically a 3D-printable semi-trailer power system for single or double configurations, integrating axial flux generators, solar films, and Stirling waste heat recovery to generate 1,483.21-5,993.3 kWh/day per semi-truck and tractor-trailer, managed by an AI-based Battery Management System (BMS). This amount of kWh/day includes tandem trailers including 3 or more trailers. It enables grid sell-back, carbon credit generation, and blockchain-secured transactions, positioning lightweight trailers (986-2,634 kg) as mobile energy nodes for enhanced grid resiliency and logistics efficiency. These carbon credits and offsets that are created will benefit both diesel and electric trucks, because companies with both kinds of trucks can lower their total cost. In the present invention, semi-trucks and tractor-trailers have a far more lightweight nature in comparison to modern semi-trucks and tractor-trailers, thus allowing less fuel to be consumed and more costs to be saved. The carbon credits can be sold back via the Blockchain, and in one version using the Hedera blockchain.

The Esustain two dimensional polyarylene (family of aromatic-backbone polymers) 2DPAF-1 (one specialty member of the family of aromatic-backbone polymers) Semi-Trailer Power System integrates modular axial flux generators (wind and mechanical), a weight-bearing superstructure with structural supercapacitors, piezoelectric elements, and solar films to generate, store, and distribute electricity. The system produces 1,166-2,446 kWh/day (907-1,794 kWh/day wind, 259-652 kWh/day mechanical, 15-150 kWh/day piezoelectric, 585.72 kWh/day solar), achieving 36.6-48.3% efficiency (wind) and 31.05-43.7% efficiency (mechanical), with a 25-year lifespan. The 2DPAF-1 works with carbon nano-lattice with nitrogen. The 2DPAF-1 also works with carbon nano-lattice polymers in regards to 3 dimensional lattice structures. Key components include:
1. The trailer weight savings with 2dpa1/carbon nano lattice polymers is substantial, it achieves a weight reduction of 2,500-5,000 kg (62.5-83.3%) compared to a standard 53 ft trailer (4,000-6,000 kg), reducing Semi EV Truck power consumption to 0.3-0.6 kWh/km (from 0.5-1 kWh/km), saving 100-400 kWh/day per trailer (200-800 kWh/day per tandem), and extending Semi EV Truck range by 50-400 km/day per trailer (100-800 km/day per tandem, total 585.97-1,750.42 km/day per trailer) when combined with the hybrid energy storage system (71.93-350.42 kWh/day), scalable to a tandem configuration (2,000-3,000 kg, 1,171.94-3,500.84 km/day).
2. Power generation with advanced solar films and co-joined axial flux systems will be highly advantageous in the new green economy. With Carbon nano lattice energy storage as a structural battery and graphene supercapacitor storage and power generation and PEDOT with embedded SSB. The system provides 3.1-21 kWh storage and 203.1-421 kWh/day power (including solar) to extend EV range by 1.55-42 km/day/trailer (321.87-643.74 km/day/tandem), scalable to a tandem configuration (6.2-42 kWh, 406.2-842 kWh/day). This will also be increase substantially via the adoption of tandems trailer and accelerate the green economy. Tandems will have a further accelerated effect
3. Blockchain integration with vehicle to V2G grid sellback incorporating of the with carbon credit and offset sales based on stored energy produced with Carbon nano lattice energy storage as a structural battery and graphene supercapacitor storage and power generation and PEDOT with embedded SSB. the system provides 3.1-21 kWh storage and 203.1-421 kWh/day power (including solar) to extend EV range by 1.55-42 km/day/trailer (321.87-643.74 km/day/tandem), scalable to a tandem configuration (6.2-42 kWh, 406.2-842 kWh/day).
4. Dynamic content management system with geo fenced advertising powered by multi-layer EL films and other solar films that allow for LCD displays for active advertising system with substantial revenue. $0.100M-$1.000M/year per trailer, $1.000M-$10.000M/year for 10 trailers), with minimal impact on aerodynamics. As well as compelling public service announcements. Allows new revenue streams for green

Research indicates USPS FY 2025 net loss: $6.9 billion A modest 100-trailer pilot generates $11.9 M-$102.6 M/year and provides a mobile grid-hardening force. Scaling to a few hundred trailers can deliver meaningful USPS cost relief, new revenue, and bolster national energy security. Mobile V2G nodes can plug into local substations to supply emergency power during SCADA attacks or outages. Deployable across major USPS distribution hubs—rapid response to harden the aging U.S. grid against cyber-physical threats and extreme weather. Dual-use fleet accelerates modernization by pre-installing standard V2G/SCADA interfaces at parcel depots.

### BRIEF DESCRIPTION OF THE DRAWINGS

Many aspects of the present disclosure can be better understood with reference to the attached drawings. The components in the drawings are not necessarily drawn to scale, with emphasis instead being placed upon clearly illustrating the principles of the disclosure. Moreover, in the drawings, like reference numerals designate corresponding parts throughout several views.

FIG. 1 is a drawing of an overview of a semi-truck and tractor-trailer after modification according to various embodiments of the present disclosure.

FIG. 2 is a drawing of a back view of the semi-truck and tractor-trailer with two air flows turning an impeller which turns axial flux shafts according to various embodiments of the present disclosure.

FIG. 3 is a drawing of a view of energy storage that shows the semi-truck and tractor-trailer with 2dpa1 panels and PEDOT material. A bottom of the energy storage indicates same storage on a bottom of the semi-truck and tractor-trailer according to various embodiments of the present disclosure.

FIG. 4 is a drawing of a basic frame skeleton of a trailer wherein materials in the frame skeleton have changed to 2dpa1/Carbon-Nano Lattice w Nitrogen according to various embodiments of the present disclosure.

FIG. 5 is a drawing of separate view of the axial flux cylinder with the individual modules which will be turned by central shaft according to various embodiments of the present disclosure.

FIG. 6 is a drawing of a Magnetically Assisted Free-Piston Stirling Heat-Recovery Linear Generator according to various embodiments of the present disclosure.

FIG. 7 is a drawing of a cutaway of polymers 2dpa1 and Carbon Nano Lattice polymer layers and connections forming a physical trailer skeleton according to various embodiments of the present disclosure.

FIG. 8 is a drawing of full layers of panels on front side, top side and floorboards of a semi-truck and tractor-trailer according to various embodiments of the present disclosure.

FIGS. 9A, 9B and 9C are drawings of ventilation views for panels according to various embodiments of the present disclosure.

FIG. 10 is a drawing of a view under semi-truck and tractor-trailer for powering axial flux cylinders via truck axel with pneumatic clutch configuration according to various embodiments of the present disclosure.

FIG. 11 is a drawing of CANbus integration with tractor with hardware device and USB and mobile application according to various embodiments of the present disclosure.

FIG. 12 is a drawing of a Multi-Source Energy Congregation Diagram wherein a first step includes an AI+Mobile App Interface, Geo-Fenced EL Displays, and a CANBus USB Connection according to various embodiments of the present disclosure.

FIG. 13 is a drawing of interior Panels of a semi-truck and tractor-trailer, including two side panel walls @ 4.0 inches thick each/Ceiling 4.5 inches thick/Front wall 4.5 inches thick/Bottom floor 4 inches thick according to various embodiments of the present disclosure.

FIG. 14 is a drawing of trailer External Side Walls, Ceiling and front wall Solar according to various embodiments of the present disclosure.

FIG. 15 is a drawing of a USB device, including an EL/LED Status Display according to various embodiments of the present disclosure.

FIG. 16 is a drawing of an internal portion of an enhanced Stirling magnetics/electromagnetics recovering heat via the linear alternator according to various embodiments of the present disclosure.

FIG. 17 is a drawing of an external portion of an enhanced Stirling magnetics/electromagnetics recovering heat via the linear alternator according to various embodiments of the present disclosure.

FIG. 18 is a drawing of according to various embodiments of energy flow of the system of the present disclosure.

FIG. 19 is a drawing of air flow over cab which is being accelerated by the Bernouli effect according to various embodiments of the present disclosure.

### DETAILED DESCRIPTION

The Esustain 2DPAF-1 Semi-Trailer Power System is a 3D-printable, lightweight solution (986-2,634 kg) for single or double configurations, integrating axial flux generators, solar films, and Stirling-type engines with integrated LaFeSi magnetocaloric cooling to generate 1,483.21-5,993.3 kWh/day per trailer (wind: 892.8-3,621.15 kWh/day, solar: 200-400 kWh/day, waste heat: 390.41-1,972.15 kWh/day), managed by an AI-based BMS. It stores energy in structural supercapacitors (500-1,000 kWh), enables grid sell-back and carbon credits via blockchain (Hedera) with quantum key distribution (QKD), and positions trailers as mobile energy nodes. Achieving 25-40%+ efficiency and a 25-year lifespan, the system enhances logistics efficiency and targets the $3B-$9B market. Key components include: 3D-printable upgrades, spintronic/photonic enhancements, and QR-secured bill of lading systems. A photonic waveguide is a structure designed to guide and confine light.

### Axial Flux

The Wind Axial Flux Modular Generator (WAFMG) for the Esustain 2DPAF-1 Semi-Trailer captures laminar airflow (10-20 m/s) via a circular inlet in the tractor cab spoiler, accelerating it to 15-70 m/s through a Bernoulli air concentrator (3:1-5:1 ratio duct). Up to 3 cylinders, each housing 5 modular graphene-based axial flux generators (180-810 kg total), are mounted on the tractor's rear wall, co-joined by a central shaft, producing 892.8-3,621.15 kWh/day (2 cylinders) to 1,339.2-5,431.725 kWh/day (3 cylinders) at 20-42% efficiency. The system integrates LaFeSi cooling, spintronics, photonics, and Stirling waste heat recovery, enhancing output and efficiency for single or tandem trailer configurations, positioning the system as a mobile energy node. For trailers in tandem, this can be installed on the front wall of the subsequent trailers.

Spintronics is a type of integrated chip that increases efficiency of electric power being generated. Photonics may be used in vacuum device taking heat. Graphene spintronic layers between 0.1-0.5 nm inside of casing in axial flux cylinder help keep magnetic waves to themselves and keep magnetic generation down.

Stirling waste heat recovery recovers heat from a Stirling device. This is an advanced vacuum in the sense that it maintains pressure below regular atmosphere and use waste heat and compression to generate power.

### Mechanical Axial Flux

The Mechanical Axial Flux Generator system for the Esustain 2DPAF-1 Semi-Trailer harnesses axle inertia (10-20 Hz, 0.1-0.5 Nm torque) via pressure plate-driven Enhanced Ratio Drive Converter (ERDC) impellers mounted under the trailer. Two cylinders (0.35-0.45 m diameter, 0.4-0.5 m length, 0.22 atm), each with 4 modular axial flux generators (total 8, 5-10 kg/cylinder), produce 259-652 kWh/day at 33-45% efficiency and 536-1,733 RPM. The system integrates 2DPA-1 rotors, NbN—CO coatings, graphene/carbon nanotube (CNT) windings, LaFeSi cooling, and passive magnetic bearings, with a clutch for on-demand operation, enhancing fuel efficiency ($100-$500 savings/trailer) and positioning the trailer as a mobile energy node.

In one embodiment, the graphene/CNT windings can be used as sheets, such that the sheets are taking the place of wire windings. Between 1000-3500 windings is an optimal amount to maximize energy generation.

A shaft in a cylinder turning a central shaft, normally would sit on bearings and have friction. With magnetic bearings it won't have as much friction, it will almost float, so there will be less friction and so less power loss. The magnetic bearings are passive because their only function is to reduce friction.

The Esustain 2DPAF-1 Semi-Trailer integrates advanced photovoltaic films across its walls and ceiling exterior (200-400 m², 1-3 kg total), leveraging perovskite, quantum dot, and electroluminescent (EL) layers with maximum power point tracking (MPPT)/field-effect transistor (FET) electronics to harvest 300-500 kWh/day. Energy is conditioned by solid-state transformers (SSTs, 5-10 kg) mounted in the upper trailer corners and stored in flexible poly(3,4-ethylenedioxythiophene) (PEDOT)-based films (500-1,000 kWh) embedded in the walls and ceiling. The EL and Quantum Dot layers enable a dynamic billboard for geofenced advertising ($2.000M-$20.000M/year for 10 tandems) and QR-coded bill of lading (0.1-0.2 m², 1-10 kB), managed via a QKD-encrypted iOS/Android app and Hedera blockchain for secure transactions, real-time scheduling, and carbon credit offsets ($1.154M-$24.519M/year for 10 tandems). An AI-based BMS optimizes distribution across wind (892.8-3,621.15 kWh/day), mechanical (259-652 kWh/day), Stirling (334.8-1,710.88 kWh/day), and solar inputs, reinforcing the trailer's role as a mobile energy node for grid resiliency.

### Exterior Photovoltaic and Dynamic Display Stack

### Solid-State Transformer (SST) Power Conditioning and Hybrid Internal Storage

The Esustain 2DPAF-1 Semi-Trailer employs solid-state transformers (SSTs, 5-10 kg total) mounted in the upper trailer corners to condition power from wind axial flux (892.8-3,621.15 kWh/day), mechanical axial flux (259-652 kWh/day), solar films (300-500 kWh/day), and Stirling waste heat (334.8-1,710.88 kWh/day), achieving a total output of 1,483.21-5,993.3 kWh/day. Energy is stored in a hybrid system of PEDOT:PSS:Gox films and electrochemical cells (5-15 kg, 500-1,000 kWh) embedded in the trailer's walls and ceiling, enhancing structural integrity alongside 2DPA-1 structural supercapacitors (100-200 kWh). An AI-based BMS optimizes power flow, supporting fast-charging (≥4 C), low-temperature operation (−30° C.), and high cycle life (≥2,000 cycles), enabling grid sell-back via Hedera smart contracts ($0.396M-$7.596M/year for 10 tandems) and positioning the trailer as a mobile energy node.

### Dynamic Content Management System (CMS) Integration With Geofenced Advertising and Operations QR Code and Bill of Lading (BOL)

The Esustain 2DPAF-1 Semi-Trailer integrates a dynamic content management system (CMS) using EL/Quantum Dot films (10-20 m², 10-20 kWh/day) on its exterior, enabling geo-fenced advertising and secure Bill of Lading (BOL) management. A geofencing module (GPS-based, 0.01-0.1 kW) activates state-specific ads, public service announcements, and QR-coded BOLs (0.1-0.2 m², 1-10 kB) at designated locations, generating $2.000M-$20.000M/year for 10 tandems. QR codes, linked to Hedera blockchain via QKD-encrypted iOS/Android app, remain inactive until reaching predefined boundaries (e.g., ports), ensuring secure logistics and tamper-proof records. An AI-based BMS optimizes power from solar films (300-500 kWh/day) and hybrid storage (500-1,000 kWh), supporting dual functionality for advertising and logistics while reinforcing the trailer's role as a mobile energy node.

The EL films may be adapted for aircraft fuselage displays, subject to future filings for aviation-specific applications displaying ads or taxiing data with 20-200 cd/m², enhancing visibility and revenue. EL film may be also used on aircraft fuselages for advertising and night taxiing.

Specification: Detail how the SST routes power (e.g., 60% to solid-state batteries (SSBs), 40% to sell-back) and how the app interfaces with the AI BMS for real-time adjustments. will make pic SST=Solid state Transformers

### Integration With Internet of Things (IoT) and Supply Chain Management: and Overseas Shipping

The system can be integrated into larger supply-chain management platforms, ensuring that dynamic data (such as updated shipment statuses or related documentation) is provided in real time. Geofenced QR codes thus become a powerful tool for automated logistics and compliance. The combination of a geofenced QR code with a blockchain-backed BOL ensures authenticity and a tamper-proof audit trail. Automated document activation through geofencing minimizes delays at ports and improves throughput at customs checkpoints. Tracking scans and location-based activations offers valuable insights into container movement, dwell times, and operational bottlenecks, which can be used to further optimize shipping processes.

When a container is loaded, its digital BOL is finalized and stored on Hedera. A QR code is generated and physically applied (or embedded) to the container's exterior. At this stage, the QR code is programmed to remain dormant. The QR code remains hidden or inert, ensuring that any scanning attempts during transit do not reveal sensitive shipping information.

Upon arrival at the predetermined location (using GPS inputs integrated within the system), the geofencing module triggers the QR code to become active. Authorized personnel scanning the code can then retrieve the digital BOL from the Hedera ledger.

### GeoFenced Advertising

Location-based display on trailer EL film updates—including state-specific advertisements, public service announcements, and secure QR codes tied to a distributed ledger (such as Hedera)—which activate only at designated geographic boundaries. These claims cover the unique aspects of the system: 1) Designated advertising with CMS system generating substantial revenue and awareness; 2) Displayed on semi-trailer panels via the active displays made possible with the film layers described; 3) Ties into the USB/Mobile app and novelty by synergy. The novelty lies in the system-level integration. The ability to dynamically prioritize energy sources, manage battery health, and even adjust ancillary systems like ad displays based on real-time operational data can set your trailer apart in terms of efficiency, flexibility, and operational intelligence. The EL display adapts to SST-optimized power, reinforcing the system's independent energy node design. The mobile app and USB device provide dual functionality, setting route-specific energy priorities via SSTs and customizing ad displays. The EL display showcases Distributed Energy Resource (DER) status, displaying the number of state-wide active trailers to promote energy trading via SSTs and Hedera. Also, fleet operators and drivers set trip-specific priorities via the mobile interface, optimizing logistics with SST-managed energy. SSTs manage dynamic logistics with user-defined parameters and ad integration.

### Trailer Structure Super Structure

The Esustain 2DPAF-1 Semi-Trailer's weight-bearing superstructure (53 ft, 200-400 m² surface area, 986-2,634 kg/single) comprises 3D-printed modular components (170-200 modules, 5-15 kg each) for walls, ceiling, support posts, chassis, coupler plate, and cross-members/roof bows, using a carbon nanolattice skeleton (50-100 Gigapascals (“GPa”)) encapsulated in 2DPA-1 (0.5-2 mm, 3.5 GPa). Integrated structural supercapacitors (100-200 kWh) and piezoelectric elements (15-50 kWh/day) enhance energy storage and harvesting, complementing PEDOT-based storage (500-1,000 kWh), totaling 600-1,200 kWh. The design reduces weight by 25-50% compared to aluminum trailers (2,000-3,500 kg), enabling rapid replacement (1-6 hours/module), retrofits (10-20% storage increase, 600-1,200 kWh), and electric vehicle (EV) range extension (100-400 km/day/trailer), supporting the trailer's role as a mobile energy node with a total output of 1,483.21-5,993.3 kWh/day.

In one embodiment of the invention, a generator system, comprising: two vacuum-sealed cylindrical housings, each having an internal pressure of 0.22 atm, a diameter of 0.35-0.45 m, a length of 0.4-0.5 m, and a mass of 5-10 kg; four modular axial-flux generators housed in each cylinder, for a total of eight modular axial-flux generators; 2DPA-1 polymer rotors and yokes, each rotor or yoke having a mass of 0.05-0.1 kg and a Young's modulus of 10-20 GPa; niobium-nitride-carbon-monoxide (NbN—CO) thin-film coatings on each rotor and yoke, the coatings having a thickness of 1-10 nm, 1-5 stacked layers, and a total coated surface area of 0.1-0.5 m², wherein the NbN—CO coatings channel 30-50 percent of the magnetic flux that would be provided by steel, corresponding to a magnetic flux density in the range of 0.45-1 Tesla.

### System Integration

Leveraging standard automotive communication protocols. This allows the device to read vehicle data—including energy storage levels, motor health, and vehicle performance—while also sending control signals. charge/discharge rates, state-of-health of energy storage, and overall system telemetry directly from the controller area network (CAN) bus, ensuring continuous communication with the vehicle's powertrain and energy management systems.

Interface with AC/DC power sources—such as on-board converters or grid-connected inverters—provides feedback on voltage levels, current loads, and conversion efficiency.

Machine learning capabilities can analyze incoming sensor data. This includes monitoring fluctuations in power usage, predicting maintenance requirements, and optimizing energy distribution for both onboard consumption and potential sellback.

Integrated monitoring device with connectivity (via USB and LTE/5G chips, as discussed earlier) plays a crucial role in bridging the gap between the trailer's advanced energy storage system and the tractor's power utilization requirements. It helps negotiate the necessary power conversion through the solid-state transformers (SSTs) and conditions the energy appropriately for effective use. In effect, this monitoring system not only tracks the performance of the structural supercapacitors but also ensures that the conditioned power, retrieved from the solar films and stored in the carbon nano lattice, is properly distributed and utilized by the tractor. It allows early detection of any issues with the energy storage system. This proactive approach can extend the lifespan of the supercapacitors and maintain system efficiency, which is especially critical in long-haul applications where energy reliability is paramount.

An AI-driven system could optimize these settings on the fly. This further ensures that the power stored in the trailer is used in the most efficient manner possible, translating to both operational savings and a smoother driving experience.

This interfaces with the mobile application that the driver utilizes to monitor AI system, blockchain transactions, energy production, and grid sellback with credits and offsets status.

### Axial Flux With Stirling Heat Energy Recovery

“The Esustain 2DPAF-1 Semi-Trailer integrates a beta-type Stirling heat recovery system (5-10 kg per module) with its wind axial flux generators (892.8-3,621.15 kWh/day, 2 cylinders) and mechanically driven generators (259-652 kWh/day, 2 cylinders), mounted with 4 cylinders total (2 on the back of the tractor, 2 on the underside of the trailer), to convert waste heat into electrical energy (334.8-1,710.88 kWh/day per trailer). Each Stirling module features repelling magnets for a pulse-boost effect, photonic sensors for piston monitoring, and spintronic actuators for magnetic field control, with multiple modules arranged in series or parallel to optimize heat capture. An AI-based BMS dynamically manages energy, using sensor feedback to adjust magnetic repulsion, disengaging solar or mechanical inputs when storage is full, and prioritizing external sources before the EV semi battery to extend operating range. A mobile app and USB liquid-crystal display (LCD) device integrate with the AI BMS and CAN bus application-programming interface (API) to control power distribution, enabling the EV semi to access power across different areas, with transactions logged on Hedera blockchain for grid sell-back ($0.396M-$7.596M/year for 10 tandems) and carbon credits ($1.154M-$24.519M/year for 10 tandems), reinforcing the trailer's role as a 3D-printable mobile energy node (986-2,634 kg per trailer).”

In one embodiment, there are varying heat inputs from the axial flux generators. Sensor feedback can determine adjustments to magnetic field strength to optimize magnetic field strength based on input from the sensor feedback. The magnetic field strength is optimized for maximum energy generation. Adjustment can take place by changing the strength of the magnetic repulsion.

“The inventors contemplate adapting the axial flux/Stirling apparatus for lunar/Mars supply chains and home generators, with separate filings to address domain-specific requirements.

### Description of Figures

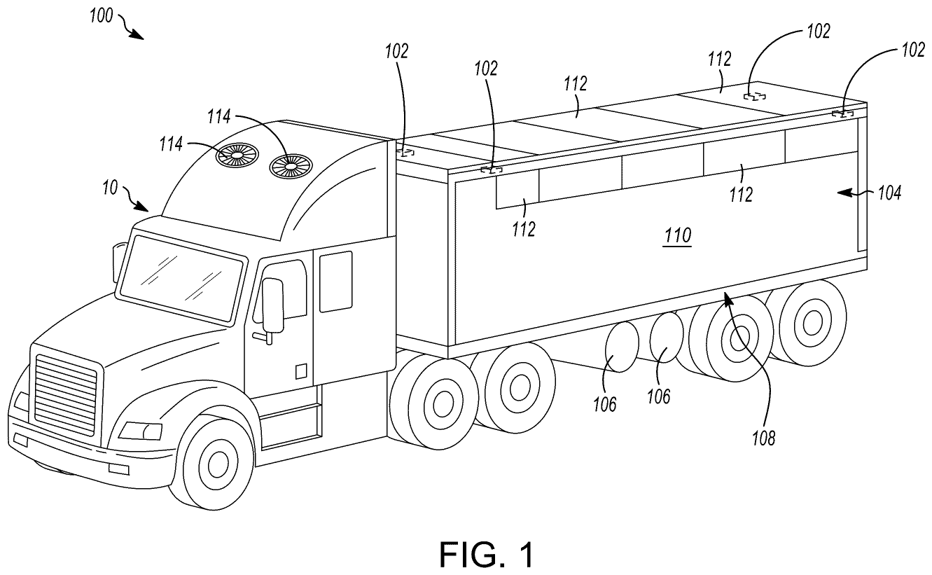

FIG. 1 details an overview of the of a semi-truck and tractor-trailer after modification.

Part 10 displays a truck Cab air deflector configured to increase airflow by ratio. Part 100 displays an overall overview of a semi truck system. Part 102 displays a solid state Transformers mounted in corners of the semi trailer. Inverts/converts power before storage. Part 104 displays trailer Panels with 2dpa1 layers embedded with PEDOT polymer and (SSB) Solid State Batteries. Part 106 displays axial fLux cojoined generators. Part 108 displays hybrid 2dpa1 frame skeleton with Carbon Nano Lattice w nitrogen structural. Part 110 displays an electro luminescent layer for geo fenced advertising. Part 112 displays solar films layers for power generation on top and sides.

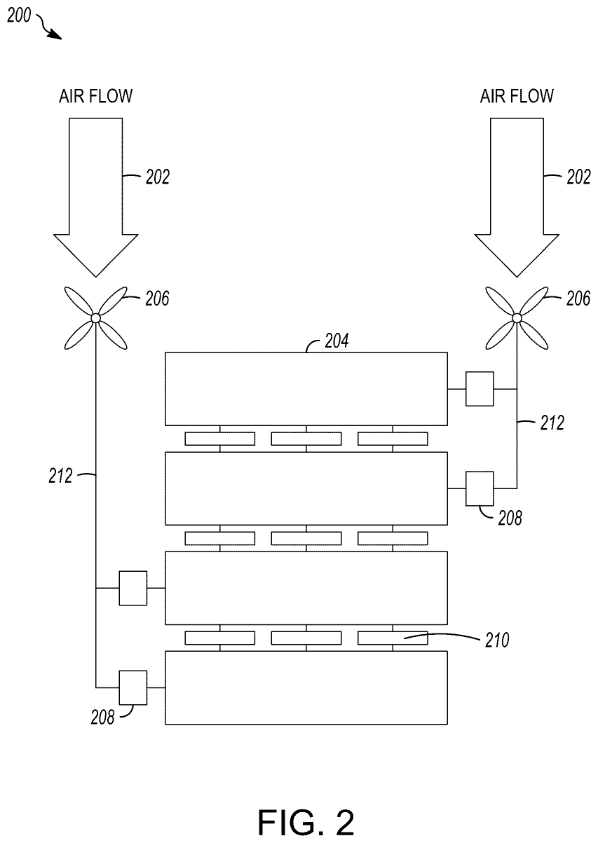

FIG. 2 shows a back view of the semi-truck and tractor-trailer with two air flows turning an impeller which turns axial flux shafts. Part 202 displays directed increased airflow path(s) coming from a specified cab deflector increased by Bernouli effect to spin impeller. Part 204 displays axial flux generators in cylinder driven by co-joined shaft and wind operations. Part 206 displays an impeller that is spun by the increased airflow to turn a designated shaft of axial flux. Part 208 displays an enhanced ratio converter gearing to an increasing shaft spin to axial flux generator. Part 210 displays a vacuum and heat recovery device to lower cylinder pressure and convert excess waste heat to electricity.

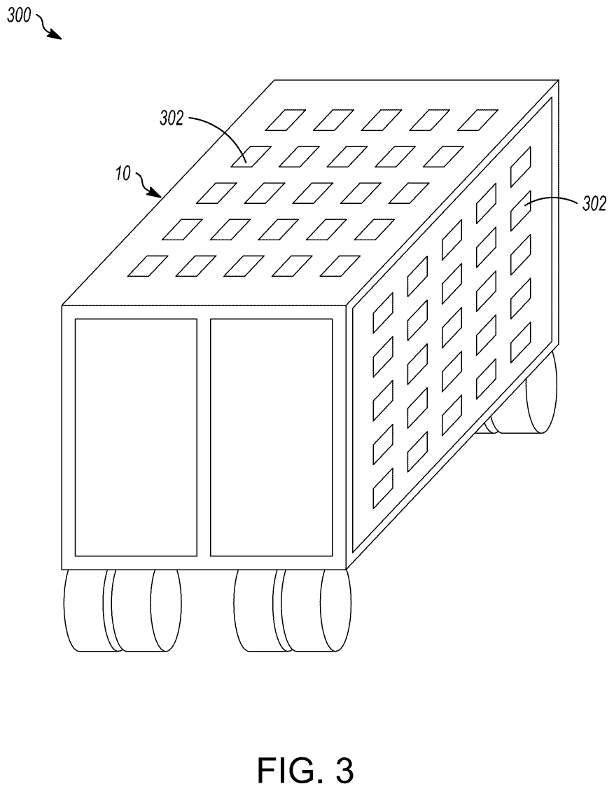

FIG. 3 displays a view of energy storage that shows the semi-truck and tractor-trailer with 2dpa1 panels and PEDOT material. A bottom of the energy storage indicates same storage on a bottom of the semi-truck and tractor-trailer. Part 10 indicates 2dpa1 polymer panels and PEDOT polymer layers for energy storage. Part 302 indicates embedded SSB batteries and graphene supercapacitors in PEDOT polymer

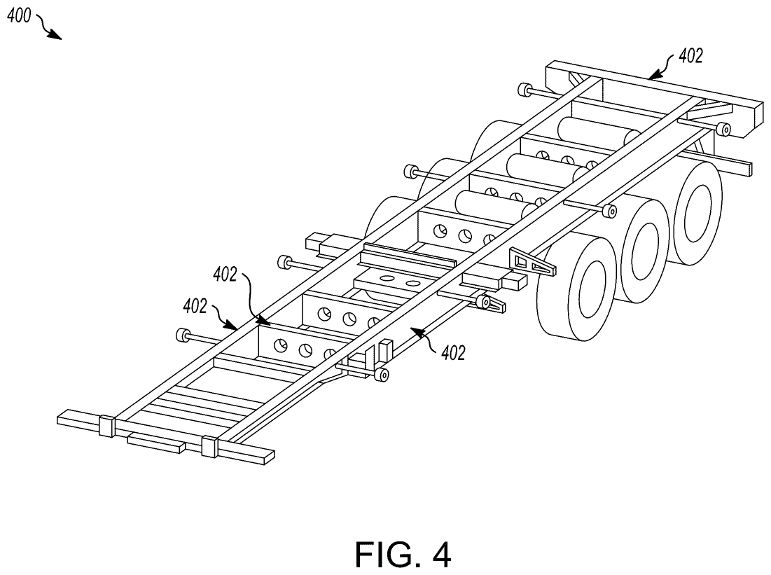

FIG. 4 displays a basic frame skeleton of a trailer wherein materials in the frame skeleton have changed to 2dpa1/Carbon-Nano Lattice w Nitrogen. Part 400 displays Everall view of a standard trailer skeleton constructed of polymer materials, cross members and trailer structure that is 3d printed. Part 402 points to cross members or trailer structure. Interlayer crosslinkers (epoxy/benzoxazine adhesives) ⋅Leverages off-the-shelf, aerospace-grade film adhesives or UV-cure prepregs. ⋅Processed on existing composite presses/autoclaves at 100-200° C. and 1-5 MPa-no new tooling required. ⋅Material cost is low (≈$5-15/kg adhesive), cure cycles are industry-standard, and bond-strength (>50 MPa) is more than sufficient for trailer cross-members.

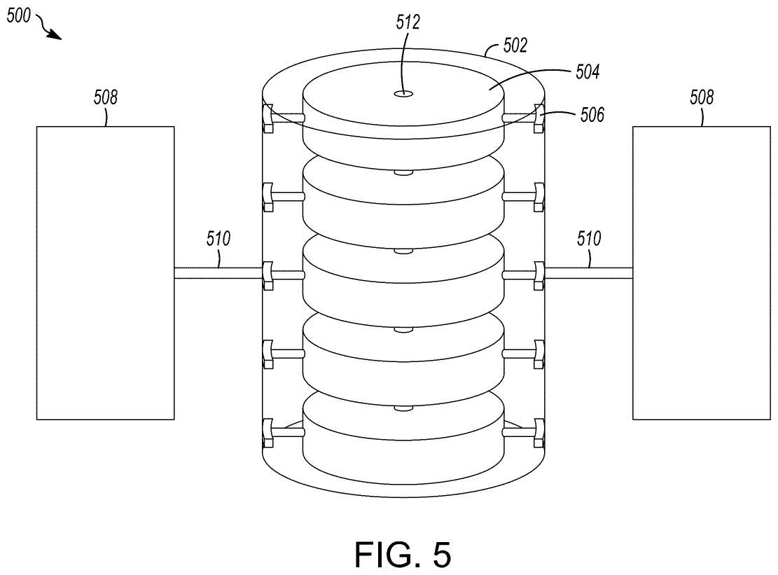

FIG. 5 shows separate views of an axial flux cylinder with individual modules that will be turned by a central shaft. Squares are depicted as enhanced sterling devices, which will be used to recover heat and turn into electricity. Part 500 displays a cylinder containing multiple axial flux generators. Part 502 displays a cylinder case material 2dpa1 polymer with a graphene inner layer film. The graphene inner layer film recovers excess heat from generators. The graphene film layer also absorbs heat in front of thermo-electric generators and converts heat to electricity for overall system. Part 504 displays multiple axial flux generators with graphene/CNT windings connected by a central cojoined shaft. Part 506 displays a cylinder mounted to a cylinder wall. Part 508 displays a Stirling vacuum heat recovery device that takes waste heat and converts the waste heat to electricity, allowing for nominal temperature in the cylinder. Part 510 displays pressure line to vacuum heat recovery devices.

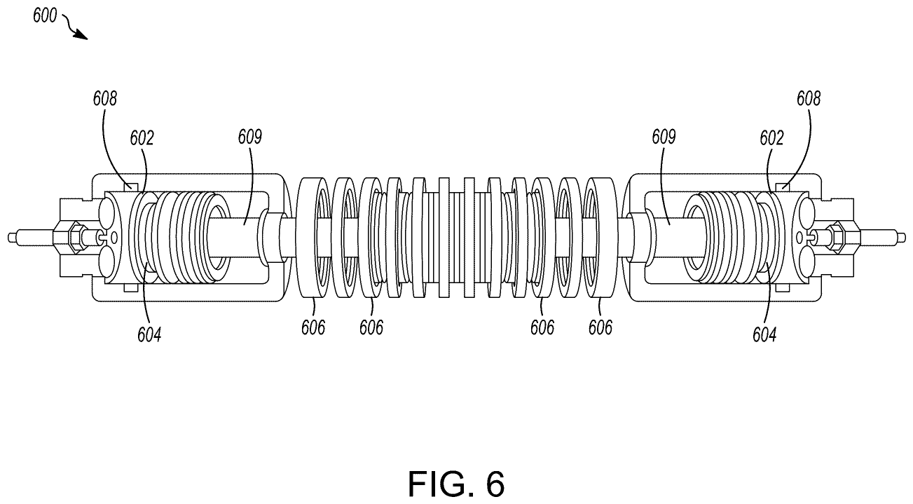

FIG. 6 displays a 600 Magnetically Assisted Free-Piston Stirling Heat-Recovery Linear Generator with linear electric motor. Part 602 displays a circular magnet with repelling force in a cylinder with graphene wraps. Part 604 displays a repelling magnet mounted on a piston surface to add boost to a repelling cycle with a marked timing indicator to interact with a laser diode for timing. Part 606 are wire coils with a magnet inside, wherein the wire coils wrap around the magnet. The magnet is also a translator or a mover that oscillates through the wire coils. Part 608 displays a laser diode with photonics that interacts with a marked magnet to integrate timing and adjust frequency of overall system. Part 609 displays a connective shaft with oscillations magnet array through coils to create additional electricity.

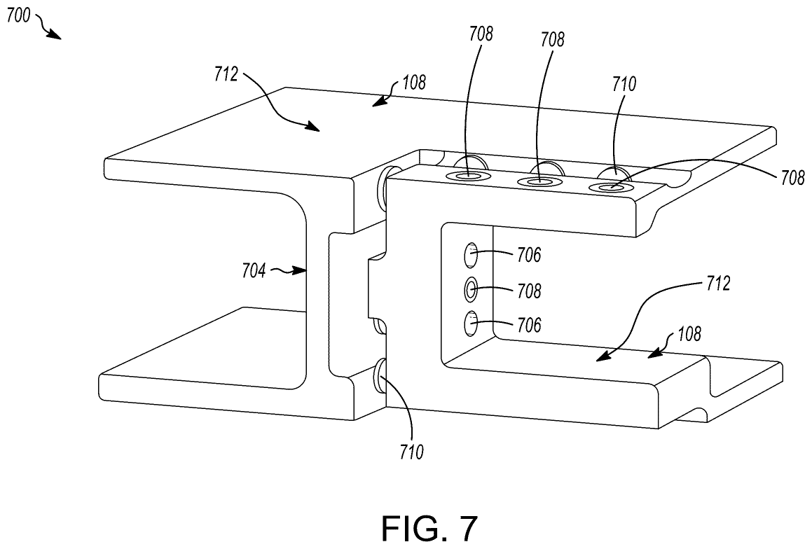

FIG. 7 displays a 700 overall picture of a cutaway of polymers 2dpa1 and Carbon Nano Lattice polymer layers and connections forming a physical trailer skeleton. There is also Lego connectivity with tongue and grove connecting layers. Part 704 displays gold electrical Contacts. Part 706 displays bolt holes. Part 708 displays Arc gold electrical contact. Part 710 displays bushings and gaskets for supportive connections. Part 108 points to 2 polymers.

FIG. 7 also explains how 2dpa-1 is related to structural supercapacitors, because it indicates a cutaway of a 2 form polymer that is assembled and connected with tongue and groove. The 2dpa1 is an exterior and carbon nanolattice/nitrogen->material that is considered structural battery material. The battery material is an interior which has electrical contacts indicated by 708 and 704. 2dpa1 is 712, Carbon nanolattice is 108. 710 is bushings and gaskets for support of assembling the structure. 706 are bolt holes.

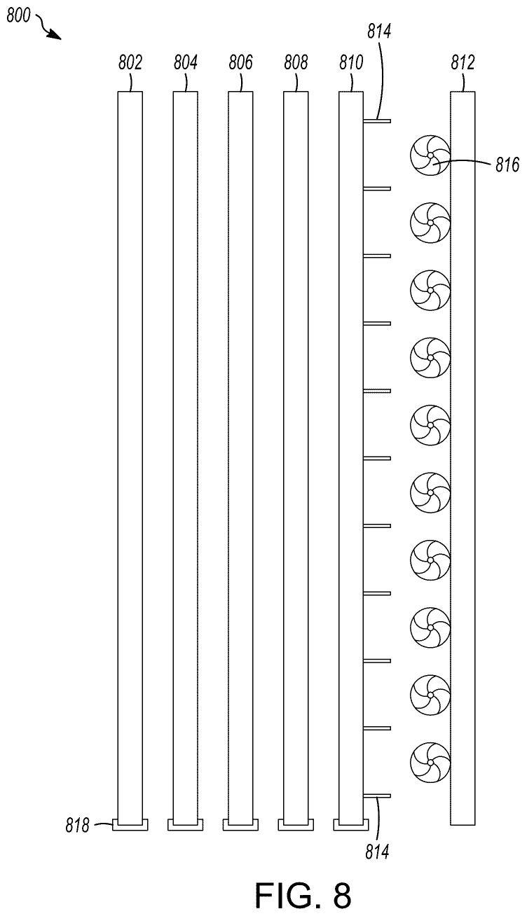

FIG. 8 displays 800 full layers of panels on front side, top side and floorboards of a semi-truck and tractor-trailer. Part 802 displays a 2dpa1 Polymer layer for outside panels. Part 804 displays an insulator. Part 806 displays a NBTi/Rare earth Barium copper oxide (“Rebco”) high temperature superconductor (“HTS”) wraps. Part 808 displays a PEDOT Polymer and embedded SSBs and supercapacitors. Part 810 displays a heatsink. Part 814 displays fins for heat dissipation. Part 812 displays a finishing wall. Part 816 display fans for heat dissipation. Part 818 displays a solar and EL film layer for power production

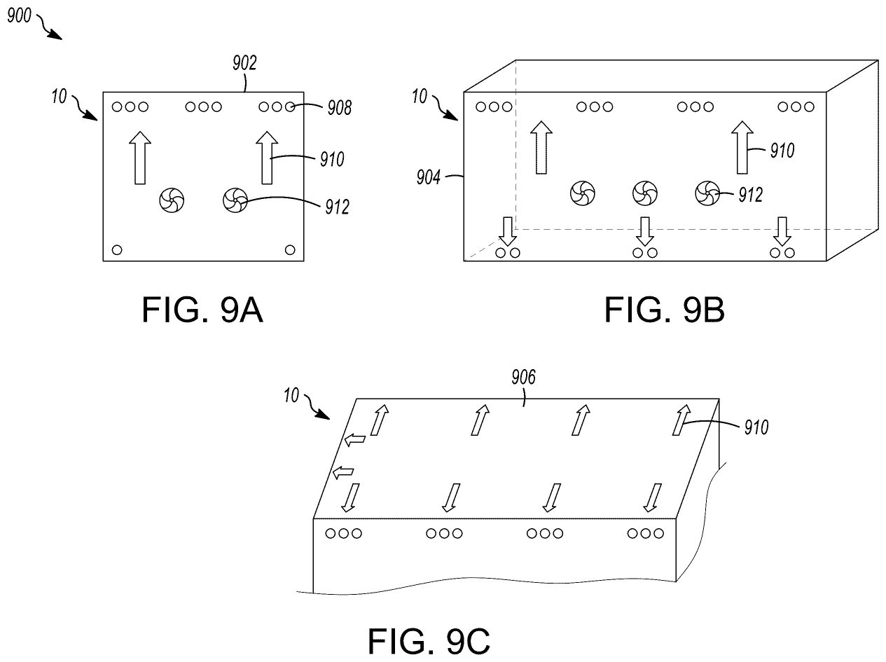

FIGS. 9A, 9B and 9C displays ventilation views for panels 900. Part 904 displays side panels of semi-truck and tractor-trailer. Part 906 displays a top ceiling panel of a semi-truck and tractor-trailer. Part 910 displays a heat air route up to ventilation. Part 912 displays circulation fans for ventilation. Part 908 is ventilation for FIG. 9A. Similar ventilation is on FIGS. 9B and 9C.

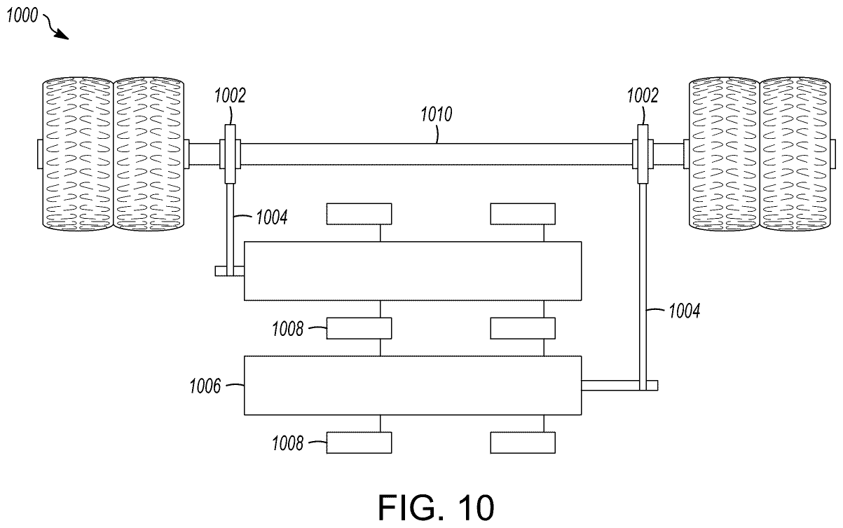

FIG. 10 displays a 1000 view under trailer for powering axial flux cylinders via truck axel with pneumatic clutch configuration. Part 1002 displays a pnuematic clutch configuration to engage and disengage from a trailer axel on demand. Part 1004 displays a belt pulley apparatus to turn axial flux central shaft. Part 1006 displays multiple axial flux generators inside of a cylinder co-joined with a central shaft for rotation. Part 1008 displays Stirling heat recovery devices for recovering heat and lowering pressure in cylinder.

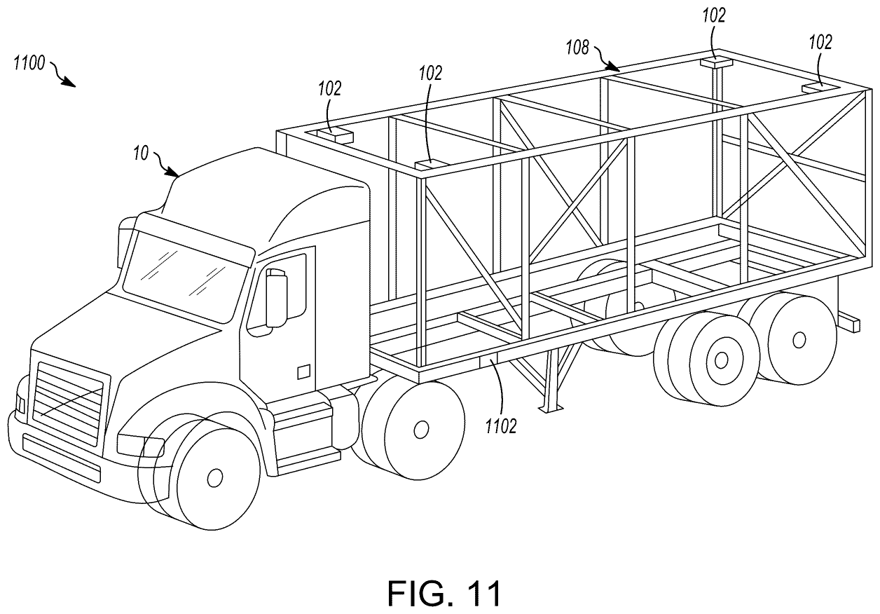

FIG. 11 displays 10 CANbus integration with tractor with hardware device and USB and mobile application. Part 102 displays Solid state Transformers mounted in semi-truck and tractor-trailer corners. Part 108 displays structural members including 3-d printed structural 2dpa1 nano carbon lattice polymer. Part 1100 displays cross member and skeleton of trailer 3 d printed components, as well as a 2dpa1 structure with carbon nano lattice for structural energy storage members. Part 1102 displays a port for grid sellback charging and energy sales activities.

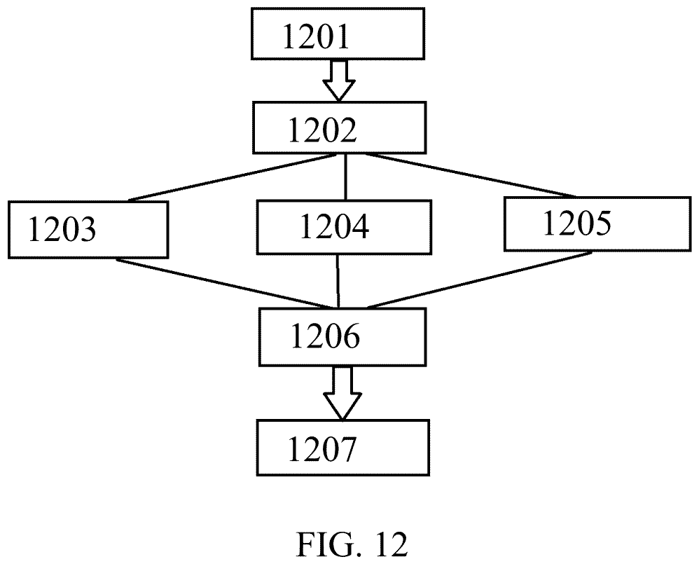

FIG. 12 shows a Multi-Source Energy Congregation Diagram wherein step 1201 includes an AI+Mobile App Interface, Geo-Fenced EL Displays, and a CANBus USB Connection. Step 1202 includes an Energy Management Controller, (Incorporates SSTs with advanced power electronics), Real time data interaction, Blockchain integration, QKD CarbonCredits Offsets and Energy V2Grid Hedera w 4 g/5 g. After step 1202, the process might go to either step 1203 or step 1204 or step 1205.

Step 1203 includes Solar Film+ (EL), Dynamic Geo, Fenced CMS, QR code int., a bill of lading and 200-400 kWh/day. Step 1204 includes Structural, Batteries+PEDOT, Based SSB, (Modular Storage), 2dpa1+nano Lat. and 3D printed Struc. Step 1205 includes Axial Flux array, Stirling Heat, Recovery Modules, magnetics+Sensor and Feedback Lafesi.

Steps 1203, 1204 and 1205 all lead to Step 1206. Step 1206 includes a Multi-Source Energy Bus, (Central power hub that harmonizes voltage/current via dedicated SSTs) inverts converts power. Step 1207 includes a vehicle, critical systems, (drivetrain, etc.)

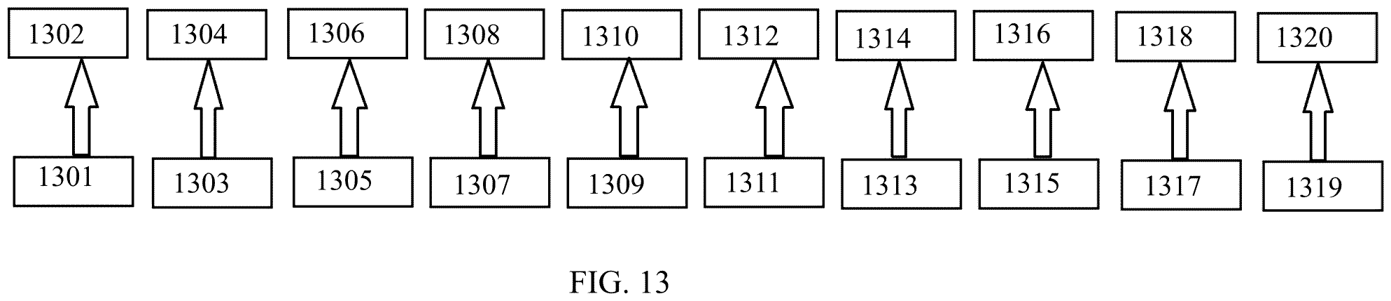

### FIG. 13

FIG. 13 describes Interior Panels of a semi-truck and tractor-trailer, including two side panel walls @ 4.0 inches thick each/Ceiling 4.5 inches thick/Front wall 4.5 inches thick/Bottom floor 4 inches thick. FIG. 13 further includes a Trailer Hybrid Cooling and Energy storage in Side Walls/Ceiling/Frontwall/Floorboards.

Part 1302 is an Outer 2DPA1 Panel that is a part 1301 Exterior structural skin. Part 1304 is an External Insulation/Reflective Layer that is a part 1303 Optional radiation barrier. Part 1306 is a REBCO NBti Shielding Layer that is a part 1305 EMF & initial heat reflection. Part 1308 is a ½-inch PEDOT Composite with Embedded SSBs & Supercapacitors that is a part 1307 Energy storage (heat sensitive). Part 1310 is a thermal Conduction Bonding Layer that is a part 1309 Transfer heat efficiently. Part 1312 is a Metal Backing with Integrated Fins (Fins Direct Heat to Air Channels) that is a part 1311 Passive Heat Sink Layer. Part 1314 is an Integrated Air Channels/Ducts (Active Ventilation Interfaces Below) that is a Part 1313 Air channels collect the rising hot air along the backing/fins, then directed upward. Part 1316 is Small Fans Installed in Ducts that is a part 1315 Active ventilation enhances airflow. Part 1318 is Upper Exhaust Vents (Roof or High Sidewall with Louvers) that is a Part 1317 Vents (placed at or near the trailer ceiling) allow the hot air to exit the trailer. Part 1320 is a Trailer Interior Finish that is a Part 1319 Final interior layer.

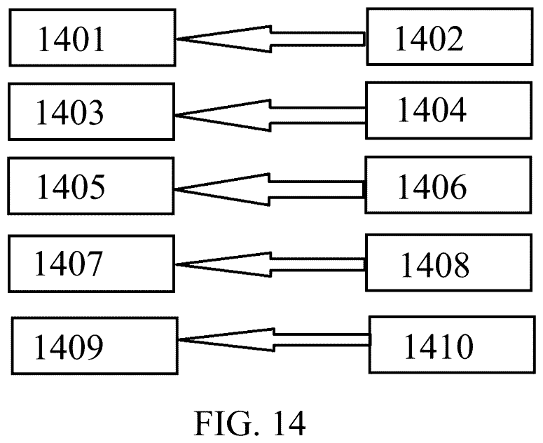

### FIG. 14

FIG. 14 describes a Trailer External Side Walls, Ceiling and front wall Solar. Part 1401 is a Dichroic Layer that Filters 1402 specific wavelengths. Part 1403 is a Perovskite+Quantum Dot Absorber that is a part 1404 Primary energy harvesting layer. Part 1405 is an Electroluminescent+Quantum Dot Layer that is a part 1406 Dynamic billboard/display function. Part 1407 is a Clear Fluorescent Layer that Down-converts 1408 high-energy photons. Part 1409 Active Perovskite Layer with MPPT, FET, & Reflective Back Electrode that Absorbs 1410 remnant light and optimizes energy conversion

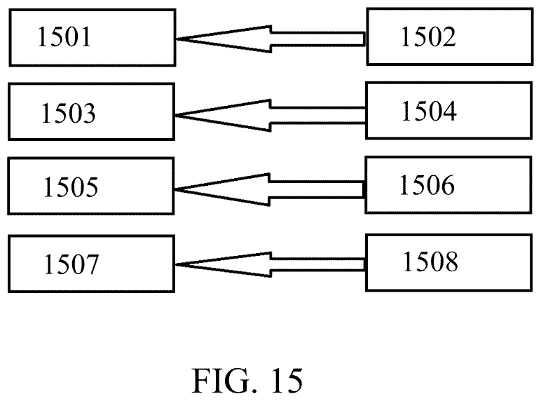

### FIG. 15

FIG. 15 describes a USB device, including part 1501, which is an EL/LED Status Display that is a part 1502 a small electroluminescent (EL) screen for real-time feedback. Part 1503 includes 3 buttons that are part 1504 Tactile buttons for user input. Part 1505 is a Touch-sensitive Panel that is a part 1506 Optional area for touch input. Part 1507 USB Type-C Connector that is a part 1508 Universal connector for power and data.

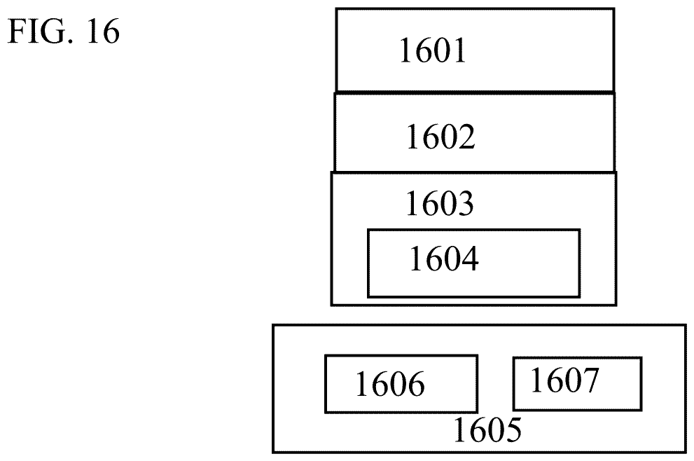

### FIG. 16

FIG. 16 describes an internal portion of an enhanced Stirling magnetics/electromagnetics recovering heat via the linear alternator. FIG. 16 includes part 1601 an outer casing (Aluminum, Composite) with Mechanical Protection, Thermal Insulation, Sealing. Part 1602 includes an Intermediate Insulating/Interface Layer (Optional). Part 1603 includes an Inner Support Layer: Graphene or Nanolattice Substrate. Part 1604 includes an Integrated Micro-Circuitry & Embedded EM Components, (Routing, Grounding, Shielding for Electromagnetic Control). Part 1605 includes an Advanced Sensor Array and includes parts 1606 and 1607, which are Integrated within an inner graphene circuit. Part 1606 includes Photonic sensors, temperature sensors and vibration sensors. Part 1607 includes spintronic sensors, position sensors and motion sensors.

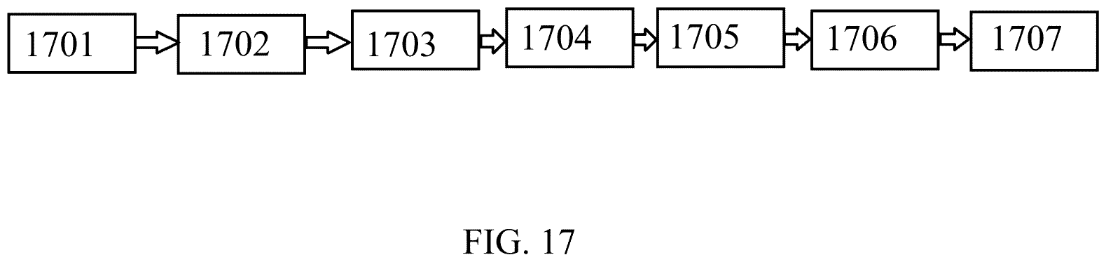

### FIG. 17

FIG. 17 describes an external portion of an enhanced Stirling magnetics/electromagnetics recovering heat via the linear alternator. FIG. 17 includes step 1701, an Axialflux Heat Source recovery (Waste Heat/Focused Thermal Energy). Step 1702 is a Heat Transfer process. Step 1703 is a Magnetic Enhanced Stirling & Displacer Apparatus (Thermal Expansion→Reciprocation). Step 1704 is Mechanical Motion. Step 1705 is a Linear Alternator Module (Moving Magnets & Stationary Coils Produce Electrical Energy). Step 1706 is Electrical Output. Step 1707 is Energy Management/Storage.

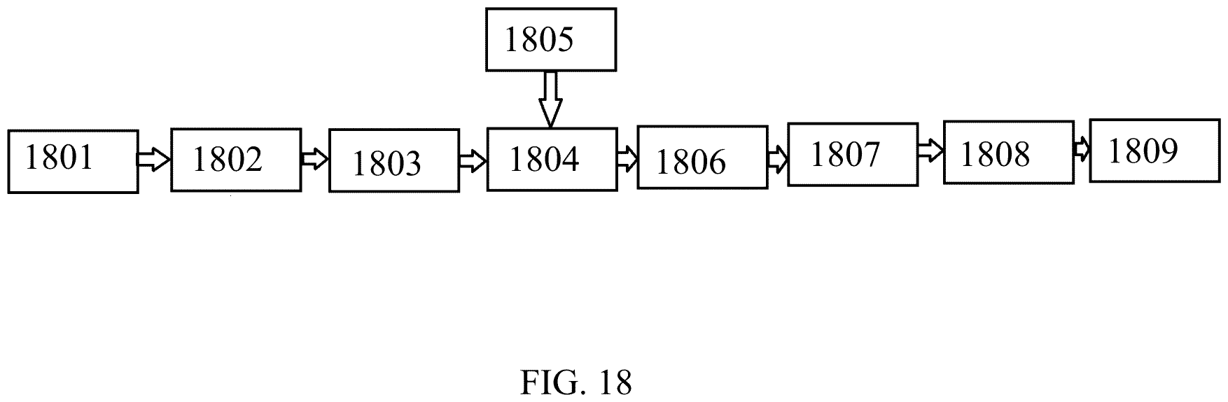

### FIG. 18

FIG. 18 describes energy flow of the system. Part 1801 is AC Input (e.g., Grid or Generator). Step 1802 includes a SST Conversion Block: Inverter/Step-Up/Down (Includes REBCO/NbTi inter-faces & Cooling). Step 1803 includes a SST Regulation Block: Power Electronics & AI Control (Advanced Switching+Soft-Switching, real-time sensors). Step 1804 includes a Multi-Source Energy Bus (Voltage & Current Conditioning via Dedicated SSTs). Part 1805 is part of step 1804, and part 1805 includes a Solar Array, Structural Batteries, PEDOT-Based SSB, Axial Flux and Generator inputs integrated). Step 1806 includes an AI Battery Management System (BMS)—Monitors storage voltage/current—Implements smart charging profiles. Step 1807 includes Low-Power EL Display (5-50 W rating, shows voltage, charge status, efficiency curves). Step 1808 includes Cooling & Super-conducting Section (Fan/Water cooled, integrates REBCO/NbTi paths for low loss power flow). Step 1909 includes Vehicle Critical Systems (Drivetrain, Auxiliary Loads).

### Flowchart TD

A[Mobile App Interface<br/>(Geo-Fenced EL Displays, User Settings)]
B[CANBus+USB Interface<br/>(Vehicle Data & Control)]
C[Energy Management Controller<br/>(Real-time data, AI BMS)]
D[Hedera Blockchain Interface<br/>(Tokenization, Carbon Credits,<br/>Sellback Transactions)]
E[QKD Secure Communication Module]
F[Multi-Source Energy Bus<br/>(Aggregates Structural Batteries,<br/>PEDOT SSBs, Solar Inputs)]
G[SST Conversion Box<br/>(Inversion/Step-Up/Down Conversion)]
H[SST Regulation Box<br/>(Advanced Power Electronics,<br/>Bi-Directional Inverter)]
I[Axial Flux Generator Array<br/>(Integrated as a Source)]
J[Stirling Beta Heat Recovery Module]
K[V2G Charger Module<br/>(Bidirectional Energy Flow)]
L[Vehicle Critical Systems<br/>(Drivetrain, Auxiliary Loads)]
%% Connections from top interface to controller
A-->C
B-->C
%% Controller directs power management and SST commands
C-->F
C-->G
C-->H
%% Multi-source energy bus gathers energy
F-->I
F-->J
%% SST blocks interface with energy bus and V2G module
G-->F
H-->K
%% V2G Module enables interaction with external grid sellback
K-->|Supply Excess Energy|D
%% Data Security Channel: QKD-enabled connection to Hedera
C--QKD Secure Data-->E
E-->D
%% Essential flows to and from Vehicle System
K-->L
%% Feedback for carbon credits, offsets, and REC tokenization
D-->A

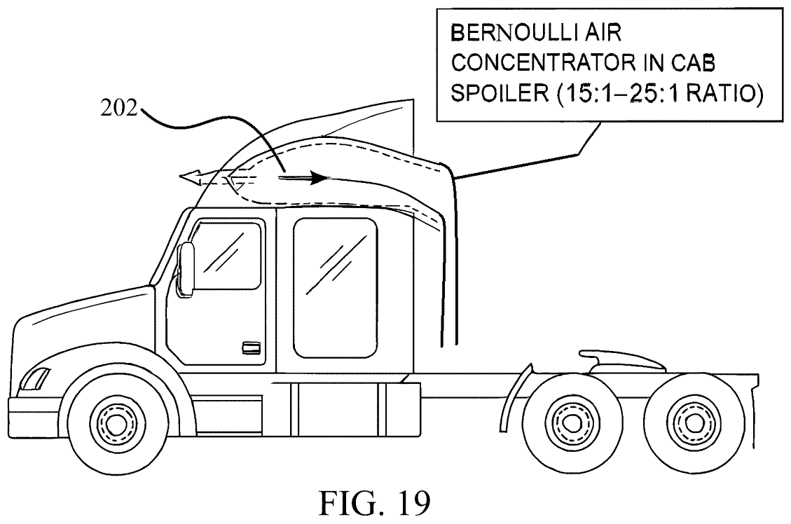

### FIG. 19

FIG. 19 describes air flow over cab which is being accelerated by the Bernouli effect. A semi-truck and tractor-trailer displaying 202 directed increased airflow path(s) coming from a specified cab deflector increased by Bernouli effect to spin impeller. Airflow 203 and airflow 204 turn downward after leaving a Bernouli air concentrator in a cab spoiler. Airflow comes in at a certain size and then decreases based on a ratio. The decrease can be either from 3 inches down to 1 inch, up to 5 inches down to 1 inch. This increases air flow and so turns the wind axial flux generator faster.

An inlet cone helps to accelerate air and takes in air into the wind axial flux generator. An optimized air tube is optimized for accelerating air so that the air goes faster.

An energy recovery device is a gear where teeth are spread out so as to make the gear spin faster, so as to turn the shaft faster. A high-efficiency blade is particular gearing in the energy recovery device. A larger gear spins a smaller gear faster, in order to speed up turn of shaft as much as possible. Conversely, a lower gear ratio (numerically smaller, meaning the driven gear has fewer teeth than the driving gear) leads to a faster output shaft speed but with reduced torque.

An axial flux generator has a pancake-like shape, and several of them fit into a cylinder. A central shaft goes through all the axial flux generators. So the same central shaft turns several axial flux generators. Graphene is light and conducts more electricity than copper, therefore axial flux generators made of graphene are more efficient in producing electricity. Within interior of a cylinder there is a film of graphene that absorbs extra heat, and this helps to not cause overheating. The excess heat is taken out through the magnetically assisted free-piston Stirling heat-recovery linear generator.

In cylinders as the axial flux generators turn, it creates heat. The less air inside the cylinders the less friction, and so less heat. The hot air can be pumped out and can be utilized to generate more electricity. That is, waste hear from each cylinder can be used to generate more electricity.

The cylinder is made of 2dpa-1, a polymer. Inside of the cylinder is a film on the inside walls. The film absorbs heat so the cylinder won't overheat.

### A Polymer Chamber

Lanthanum Iron Silicon (“LaFeSi”) magnetocaloric cooling is a new form of cooling using magnets to cool the polymer chamber or cylinder. This allows avoiding refrigerants for cooling. Integrated cooling includes 2-3 methods of cooling. 1 is vacuum, 2 is graphene, and 3 is LaFeSi magnetocaloric cooling. Integrated cooling can utilize all 3 of those methods at the same time.

The techniques, materials and designs can be applied to any vehicle, including space vehicles, cars and semi-trucks and tractor-trailers.

A venturi-shaped duct refers to airflow incoming from cab of semi-truck and tractor-trailer. As air comes in the shape of duct decreases so that the air is accelerated when it exits the duct.

### Conclusion for the Esustain 2DPAF-1 Semi-Trailer Power System

The Esustain 2DPAF-1 Semi-Trailer Power System represents a groundbreaking advancement in sustainable freight transportation, transforming Class 8 semi-truck and tractor-trailers into mobile energy nodes that maximize energy production, revenue generation, and environmental impact. Through an integrated, multi-modal energy harvesting approach, the system leverages wind axial flux generators (892.8-3,621.15 kWh/day), mechanically driven generators (259-652 kWh/day), solar films (300-500 kWh/day), Magnetically Assisted Free-Piston Stirling Heat-Recovery Linear Generator Stirling heat recovery (334.8-1,710.88 kWh/day), and piezoelectric sources (15-50 kWh/day) to achieve a total output of 1,483.21-5,993.3 kWh/day per trailer. This innovative design, detailed across 58 plus claims, ensures lightweight construction (986-2,634 kg per trailer), 3D-printable upgrades, and an extended EV range of 585.97-1,750.42 km/day, supporting the transition to zero-emission logistics. Once one company adopts this method, other companies may be forced to adopt it as well.

The system's core strength lies in its AI-based Battery Management System (BMS), which dynamically optimizes power distribution across all sources, prioritizing external energy before tapping into the EV semi battery (claim 5, Stirling section). The AI BMS interfaces with a CAN bus API to route power (300-1,200 kWh/day) to the EV semi, enabling efficient operation over long distances (500-1,000 km/day at 0.3-0.6 kWh/km). Enhanced by a USB LCD device and mobile app, the system offers real-time monitoring and control, adjusting priorities based on route, weather, and destination conditions (claims 6 and 7, Stirling section), ensuring maximum energy utilization and user customization.

A key innovation is the Stirling heat recovery system, which converts waste heat from 4 axial flux generator cylinders (2 wind, 2 mechanical) into electrical energy (334.8-1,710.88 kWh/day), using lanthanum-iron-silicon (LaFeSi) magnetocaloric cooling to boost efficiency by 5-10% (claim 2, Stirling section). The AI BMS dynamically switches to prioritize Stirling power when storage (600-1,200 kWh) is full, disengaging other sources like solar or wind to maximize production (claim 4, Stirling section). Excess energy (1,083.21-5,193.3 kWh/day) is sold back to the grid at $0.1-$0.4/kWh, generating $0.396M-$7.596M/year for 10 tandems, while carbon credits are enhanced by 20-50%, yielding $1.154M-$24.519M/year for 10 tandems (claim 3, Stirling section). The USB LCD device, mobile app, and AI BMS further integrate with the Hedera blockchain to track energy production, calculate carbon offsets, and manage these transactions transparently, reinforcing the system's environmental and financial benefits (claim 8, Stirling section).

Additional innovations include the Wind Axial Flux Modular Generator (WAFMG) system (14 claims), which captures wind energy at 20-40% efficiency, and the mechanically driven generators (12 claims), which harness kinetic energy during transit. The solar films, integrated across 5 layers, provide consistent power in varying conditions, while the SST/storage system (10 claims) ensures efficient energy storage with PEDOT and supercapacitors. The Dynamic CMS (8 claims) monetizes advertising space ($2.000M-$20.000M/year for 10 tandems) via a QKD-encrypted app with Hedera blockchain integration, and the superstructure (6 claims) optimizes aerodynamics and structural integrity. Together, these components create a holistic system that not only powers the EV semi but also contributes to grid resiliency and sustainability.

The Esustain 2DPAF-1 is poised for real-world validation through the Q3 2025 pilot, where its energy production, AI-driven optimization, and blockchain-based monetization will be tested. By combining advanced technology with practical design, this system sets a new standard for the freight industry, delivering economic value ($3.550M-$52.115M/year for 10 tandems across energy, credits, and advertising) and environmental impact, paving the way for a future of sustainable, energy-independent transportation. For example, in Australia, there are multiple road trains that could benefit from the technology with carbon credits ($1.154M-$24.519M/year for 10 tandems).

The following embodiments can be combined with each other in any manner: a modular Wind Axial Flux Method Generators (“WAFMG”) comprising: an airflow intake system circular inlet within a tractor cab spoiler, capturing laminar airflow via Bernoulli's principle; and wherein the laminar air flow is between 10 and 20 meters per second. In one embodiment there is an inlet cone; a converging duct that is 5.5 feet in length; wherein the converging duct is behind the inlet cone; the converging duct having a 0.5-1 m² inlet and incrementally decreasing to a 0.02-0.0667 m² outlet; with a 3:1-5:1 ratio of converging duct that empties airflow onto an impeller; and wherein the converging duct causes airflow to accelerate to 15-70 m/s. In another embodiment: an energy recovery device (“ERD”) converts airflow into a mechanical shaft rotation with high-efficiency blade geometry. In another embodiment: an axial flux generator system with 2-3 cylinders; wherein each cylinder has 5 modular graphene-based axial flux generators; wherein each modular graphene-based axial flux generator is 180-810 kilograms (“kg”) total; wherein the 2-3 cylinders are mounted on a semi-truck and tractor-trailer's rear wall; and wherein the 2-3 cylinders are co-joined by a central shaft acting as a power multiplier.

In another embodiment: a vacuum-sealed polymer chamber: two dimensional polyarylene (“2DPA-1”) polymer at 0.22 atmosphere (“atm”) to reduce air resistance and enhance cooling. In another embodiment: Lanthanum Iron Silicon (“LaFeSi”) magnetocaloric cooling with graphene film; wherein integrated cooling includes vacuum cooling, graphene cooling, and LaFeSi magnetocaloric cooling all at once; wherein integrated cooling is 100-500 Watts (“W”)/kg; wherein graphene-layered cylinder walls weigh 0.1-0.5 kg; and wherein graphene-layered cylinder walls manage heat and boost efficiency. In another embodiment: spintronics and photonics integration, such that both spintronics and photonics are utilized at once; wherein there are Graphene spintronic layers between 0.1-0.5 nm inside of casing in axial flux cylinder; wherein there are photonic waveguides between 0.01-0.05 kg inside of casing in axial flux cylinder; wherein the Graphene spintronic layers and photonic waveguides eliminate electromagnetic interference (“EMI”) and increases efficiency, respectively.

In another embodiment: wherein passive magnetic bearings are on shaft and generators for higher rotations per minute (“RPM”), reducing friction and heat. In another embodiment: Stirling Waste Heat Recovery: wherein 2-5 Stirling-type engines with LaFeSi cooling modification recover 1,339.2-5,431.725 kilowatt-hours (“kWh”)/day of waste heat per semi-truck and tractor-trailer, adding 334.8-1,710.88 kWh/day of power. In another embodiment: a circular air intake vent within the tractor cab spoiler; wherein the circular air intake captures laminar airflow at 10-20 m/s; wherein an inlet cone and narrowing airflow duct with a fixed inlet protrusion accelerate air velocity to 15-70 m/s; and wherein an ERD coupled to a central shaft converts airflow energy into mechanical rotational motion. In another embodiment: wherein the air intake is a circular inlet (5-inch diameter) transitioning into a venturi-shaped duct (0.5-1 m² inlet to 0.02-0.0667 m² outlet, 3:1-5:1 ratio), producing 892.8-3,621.15 kWh/day (2 cylinders) to 1,339.2-5,431.725 kWh/day (3 cylinders). In another embodiment: wherein the ERD uses high-efficiency blade geometry to convert airflow kinetic energy into shaft torque at 15-70 m/s (5% losses).

In another embodiment: wherein 2-3 cylinders, each with 5 modular graphene-based axial flux generators that weigh 180-810 kg total; wherein each cylinder is mounted on a semi-truck and tractor-trailer's rear wall; wherein there are Graphene/Carbon Nanotube (“CNT”) multilayer interleaved windings; wherein each Graphene/CNT multilayer interleaved winding is 500-5,000 Sheets/m2 for enhanced electrical conductivity; wherein there is a vacuum-sealed cylindrical housing of 2DPA-1 polymer; and wherein pressure inside the housing is 0.22 atm. In another embodiment: wherein integrated LaFeSi magnetocaloric cooling at a rate of 100-500 W/kg; wherein graphene-layered cylinder walls that weigh 0.1-0.5 kg each; and wherein the cooling and walls reduce thermal losses and improve efficiency by 5-10%. In another embodiment: wherein spintronic components that are 0.1-0.5 nm graphene layers reduce electromagnetic interference, and boost efficiency of energy production by 2-5%. In another embodiment: wherein photonic waveguides that are 0.01-0.05 kg eliminate signal loss due to EMI, increasing efficiency by 1-2%. In another embodiment: wherein graphene or CNT windings increase electrical conductivity by 35% compared to copper, with lightweight 2DPA-1 rotors coated with NbN—CO thin films to manage magnetic fields, synergizing with LaFeSi cooling. In another embodiment: wherein the vacuum-sealed chamber at 0.22 atm enhances heat dissipation and power efficiency via a vacuum pump. In another embodiment: wherein passive magnetic bearings on the central shaft and modular generators increase RPM, reducing friction and heat.

In another embodiment: wherein the wind axial flux generators produce 892.8-3,621.15 kWh/day (2 cylinders) to 1,339.2-5,431.725 kWh/day (3 cylinders) at 20-42% efficiency, scalable for single (1,000-1,500 kg) or tandem (2,000-3,000 kg) configurations with additional cylinders on subsequent semi-trucks and tractor-trailers. In another embodiment: wherein 2-5 Stirling-type engines with integrated LaFeSi magnetocaloric cooling (1-5 kW each, 12-125 kg total, 25-35% efficiency with 5-10% boost) recover 1,339.2-5,431.725 kWh/day of waste heat per semi-truck and tractor-trailer, adding 334.8-1,710.88 kWh/day. In another embodiment: wherein an artificial intelligence (“AI”)-driven energy management system optimizes power distribution between wind axial flux generators, solar films (300-500 kWh/day), Stirling (334.8-1,710.88 kWh/day), and hybrid storage (500-1,000 kWh), enabling grid sell-back via Hedera smart contracts. In another embodiment: wherein three dimensional (“3D”)-printable upgrades (1-2 weeks) ensure lightweight integration (total semi-truck and tractor-trailer weight 986-2,634 kg, tandem 1,972-5,268 kg), positioning semi-trucks and tractor-trailers as mobile energy nodes. In another embodiment: Smart Energy Management: An artificial intelligence (“AI”)-driven energy management system to optimize power distribution between axial flux generators, supercapacitors, hybrid Poly(3,4-ethylenedioxythiophene) (“PEDOT”) energy storage, and solar/wind inputs, structural supercapacitors and Solid State Transformers (“SST”) enhancing efficiency.

In another embodiment: Magnetic bearings on shaft and generators for higher RPM; 2-5 Stirling-type engines with LaFeSi cooling recover 1,339.2-5,431.725 kWh/day of waste heat, adding 334.8-1,710.88 kWh/day. In another embodiment: A semi-truck and tractor-trailer power system comprising: pressure plates (0.1-0.5 m², 0.1-0.3 kg) capturing axle inertia (10-20 Hz, 0.1-0.5 Nm torque); Enhanced Ratio Drive Converter (“ERDC”) impellers (0.3-0.5 m diameter, 6-12 carbon fiber blades, 0.5-1 kg) driven at 100-500 RPM; and an ERD torque boost mechanism coupled to a central shaft, converting mechanical energy into rotational motion. In another embodiment: The system of claim 26, further comprising: wherein the ERD includes planetary gears (2:1-5:1 ratio, 0.3-0.5 kg) amplifying torque by 20-50% (0.24-1.5 Nm/cylinder), driving a Kevlar belt (1-2 m, 0.1-0.2 kg) and carbon fiber shaft (1-2 kg), producing 259-652 kWh/day. In another embodiment: wherein a clutch/actuator engages the ERD at 100-500 RPM and disengages when idle, optimizing efficiency (0-0.05% loss) in terms of energy loss per semi-truck and tractor-trailer. In another embodiment: A generator system, comprising: two vacuum-sealed cylindrical housings, each having an internal pressure of 0.22 atm, a diameter of 0.35-0.45 m, a length of 0.4-0.5 m, and a mass of 5-10 kg; four modular axial-flux generators housed in each cylindrical housing, for a total of eight modular axial-flux generators; 2DPA-1 polymer rotors and yokes, each rotor or yoke having a mass of 0.05-0.1 kg and a Young's modulus of 10-20 Gigapascals (“GPa”); niobium-nitride-carbon-monoxide (NbN—CO) thin-film coatings on each rotor and yoke; wherein the coatings have a thickness of 1-10 nm; wherein the coatings have 1-5 stacked layers; wherein total coated surface area is 0.1-0.5 m²; and wherein the coatings channel 30-50 percent of magnetic flux that would be provided by steel, corresponding to a magnetic flux density in the range of 0.45-1 Tesla (“T”).

In another embodiment: wherein graphene/CNT interleaved windings (0.01-0.1 kg, 50-500 S/m) increase output by 20-42% (4.15-17.93 kW/unit), achieving 259-652 kWh/day at 536-1,733 RPM. In another embodiment: wherein integrated LaFeSi magnetocaloric cooling (0.1-0.5 kg, 4-20 K) and graphene films (0.5-2 m²/cylinder, 0.0001-0.001 kg/m²) reduce thermal losses by 10-20% (0.166-1.912 kWh per semi-truck and tractor-trailer). In another embodiment: wherein passive magnetic bearings reduce friction by 0.1-0.5%; wherein spintronic layers (0.1-0.5 nm) with photonic waveguides (0.01-0.05 kg) eliminate EMI; and wherein this results in boosting efficiency in energy production by 1-5%. In another embodiment: wherein the system achieves 33-45% more efficiency in energy production; wherein the system produces 259-652 kWh/day; and wherein NbN—CO coatings synergize with LaFeSi cooling. In another embodiment: wherein a vacuum-sealed chamber has a pressure of 0.22 atm; wherein the vacuum-sealed chamber enhances heat dissipation and power efficiency via a vacuum pump. In another embodiment: wherein an AI-driven energy management system optimizes power distribution between mechanical generators (259-652 kWh/day), wind axial flux (892.8-3,621.15 kWh/day), solar films (300-500 kWh/day), Stirling (334.8-1,710.88 kWh/day), and hybrid storage (500-1,000 kWh), enabling grid sell-back via Hedera smart contracts.

In another embodiment: wherein 3D-printable upgrades take 1-2 weeks; wherein 3D-printable upgrades ensure lightweight integration; wherein total semi-truck and tractor-trailer weight is 986-2,634 kg; wherein tandem weight is 1,972-5,268 kg; and wherein the 3D-printable upgrades enhance fuel efficiency. In another embodiment: wherein 2-5 Stirling-type engines with integrated LaFeSi cooling (1-5 kW each, 12-125 kg total, 25-35% efficiency with 5-10% boost) recover 1,339.2-5,431.725 kWh/day of waste heat from mechanical and wind generators, adding 334.8-1,710.88 kWh/day. In another embodiment: a top encapsulation & protective layer for a semi-truck and tractor-trailer, comprising: a transparent 2DPA-1 polymeric layer; wherein the polymeric layer weighs between 0.5-1 kg; wherein the polymeric layer has an anti-reflective, nanostructured dichroic surface that reduces heat; wherein reduction of heat is between 10-20%; and wherein the polymeric layer enhances light trapping for underlying photovoltaic layers. In another embodiment: An optical enhancement or textured light-trapping layer (layer 2) for a semi-truck and tractor-trailer: wherein a Perovskite layer absorbs a broad spectrum of light; wherein the Perovskite layer increases 15-25% efficiency of power production; wherein the Perovskite layer is enhanced by Quantum Dots; wherein the Quantum Dots provide a 5-10% low-light boost; wherein the low-light boost yields 300-500 kWh/day across 200-400 m² of Perovskite layer.

In another embodiment: Dynamic electroluminescent (“EL”) and quantum dot layers: wherein EL emits light; wherein the EL and quantum dot layers are tuned by Quantum Dots; wherein the Quantum Dots weigh 0.5-1 kg total; wherein the Quantum Dots enable a dynamic billboard for geo-fenced advertising, public service announcements, and quick response (“QR”)-coded bill of lading; wherein density of the Quantum Dots is 0.1-0.2 m²; wherein 1-10 kB encoding shipment data includes Identification, origin, destination and weight; wherein the EL and quantum dot layers are integrated with a Quantum Key Distribution (“QKD”)-encrypted iOS/Android app; and wherein there is Hedera blockchain for ad scheduling, logistics management and carbon credit tracking. In another embodiment: A transparent conductive electrode(s): wherein graphene or silver nanowire networks weigh between 0.1-0.5 kg; wherein graphene or silver nanowire networks provide electrical connections for display; and wherein graphene or silver nanowire networks transmit light to photovoltaic layers. In another embodiment: A Perovskite photovoltaic active layer: wherein the perovskite layer acts as the primary light-absorbing and energy-converting medium; wherein the perovskite layer is optimized for high conversion efficiency and broad spectral response; and wherein the perovskite layer benefits from enhanced light-trapping effects imparted by a textured layer above the perovskite layer. In another embodiment: Maximum power point tracking (“MPPT”)/Printed Electronics Layer and Back Electrode: a printed electronics layer with Field effect transistors (“FET”) and MPPT circuitry; wherein the printed electronics layer weighs between 0.5-1 kg; wherein the printed electronics layer optimizes power extraction; wherein the power extraction sees a 5-10% efficiency gain; and wherein the printed electronics layer includes a back electrode reflecting unabsorbed light into a Perovskite layer. In another embodiment: Solid State Transformers (SSTs): an integrated energy conditioning and storage system for a semi-truck and tractor-trailer platform, comprising: Solid-state transformers (“SSTs”) mounted in upper corners of the semi-truck and tractor-trailer; wherein the SSTs weigh 5-10 kg total; wherein the SSTs condition power from wind axial flux generators resulting in 892.8-3,621.15 kWh/day; wherein the SSTs condition power from mechanical axial flux generators resulting in 259-652 kWh/day; wherein the SSTs condition power from photovoltaic films resulting in 300-500 kWh/day; wherein the SSTs condition power from Stirling waste heat recovery resulting in 334.8-1,710.88 kWh/day; wherein a hybrid energy storage system is embedded in the semi-truck and tractor-trailer's walls and ceiling; wherein the hybrid energy storage system weighs 5-15 kg, wherein the hybrid energy storage system comprises PEDOT and polystyrene sulfonate and graphene oxide (“PEDOT:PSS:Gox”) films and electrochemical cells; wherein the electrochemical cells are greater than 200 Wh/kg; wherein the electrochemical cells have between 500-1,000 kWh capacity; wherein the hybrid energy storage system is integrated with 2DPA-1 structural supercapacitors (100-200 kWh); and wherein an AI-based battery management system (“BMS”) optimizes power flow, supporting grid sell-back via Hedera smart contracts. In another embodiment: flexible hybrid energy storage modules, wherein the SSTs incorporate spintronic switching elements and photonic control circuitry, improving alternating current-direct current (“AC-DC”) conversion and inversion efficiency by 10-15%. In another embodiment: an energy management and control system: wherein the SSTs provide voltage isolation and conditioning for onboard loads, including dynamic billboard content management and power beaming for docking operations.

In another embodiment: A hybrid energy storage system embedded in the 2DPAF-1 structure's floorboards, walls, and ceiling, comprising a conductive polymer matrix (e.g., PEDOT) and one or more electrochemical cells or equivalent energy storage devices; wherein the electrochemical cells or equivalent energy storage devices can be selected from any combination of batteries, supercapacitors, fuel cells, solid-state, lithium-iron-phosphate, sodium-ion, and hybrid configurations with energy density greater than 200 Wh/kg or equivalent performance; wherein the electrochemical cells or equivalent energy storage device is configured to store energy from the wind axial flux generators, mechanical axial flux generators, and photovoltaic cells; and wherein a battery management system supporting fast-charging (e.g., ≥4 C), low-temperature operation (e.g., −30° C. charging), and high cycle life (e.g., ≥2,000 cycles); In another embodiment: wherein PEDOT:PSS:Gox films are produced via solution-based deposition; and wherein the PEDOT:PSS:Gox films enhance structural integrity alongside 2DPA-1 structural supercapacitors.

In another embodiment: wherein sidewalls and ceiling and floorboards of a semi-truck and tractor-trailer incorporate PEDOT:PSS with embedded thin solid state batteries (“SSBs”); wherein the SSBs are 20-40 kWh and 200-400 Wh/kg; wherein the SSBs provide structural energy storage and electromagnetic field (“EMF”) shielding via high temperature superconductor (“HTS”) rare earth Barium copper oxide (“Rebco”) wrapping, managed by SSTs and AI BMS to extend EV range by 50-100 km/day; and distinct from conventional EV battery packs through multi-functional structural integration. In another embodiment: wherein the AI-based BMS implements MPPT algorithms to optimize energy harvest from solar films and other sources, ensuring efficient distribution across all onboard systems. In another embodiment: wherein the hybrid storage system supports a total capacity of 500-1,000 kWh, storing energy from all generation sources for grid resiliency. In another embodiment: wherein the semi-truck and tractor-trailer's produces a total energy output of 1,483.21-5,993.3 kWh/day; wherein the semi-truck and tractor-trailer's energy production allows it to act as a mobile energy node for logistics and grid support. In another embodiment: wherein 3D-printable upgrades (1-2 weeks) ensure lightweight integration (total semi-truck and tractor-trailer weight 986-2,634 kg, tandem 1,972-5,268 kg). In another embodiment: wherein the AI-based BMS enables carbon credit offsets via Hedera blockchain integration. In another embodiment: wherein sidewalls and ceiling, floorboards incorporate PEDOT:PSS with embedded thin SSBs, providing 10-20 kWh structural energy storage, wrapped with HTS REBCO for EMF shielding and heat reflection, managed by SSTs and AI BMS.

In another embodiment: A dynamic content management system for a semi-truck and tractor-trailer platform, comprising: a dynamic display integrated into the semi-truck and tractor-trailer's exterior (10-20 m²) using EL/Quantum Dot films, capable of updating visual content in real-time; a geo-fencing module (GPS-based, 0.01-0.1 kW) detecting the semi-truck and tractor-trailer's location within a 1-10 km radius; wherein a control unit uses 0.1-0.5 kW; wherein the control unit updates content; wherein content includes state-specific ads, public service announcements, QR-coded Bills of Lading (“BOLs”); wherein content is updated upon crossing predefined geographic boundaries; wherein QR codes are 0.1-0.2 m²; wherein QR codes utilize 1-10 kB of bandwidth; wherein QR codes are cryptographically linked to a Hedera blockchain, activated only at designated locations for secure verification; and wherein the control unit adjusts ad display based on available power from Stirling or wind sources. In another embodiment: wherein a dynamic content management system (“CMS”) electronic (“EL”) display is integrated with a multi-source energy congregation system, comprising axial flux wind generators (892.8-3,621.15 kWh/day), solar films (200-400 kWh/day), and Stirling heat recovery (421.48-2,218.79 kWh/day), managed by a Solid State Transformer (SST, 98-99% efficiency) and an AI BMS to optimize power flow to an electric vehicle (“EV”) semi battery and display; wherein the display adjusts content in real-time based on route data and energy forecasts, switching to text-only ads during low energy; wherein low energy is 20 cd/m² or less; wherein the display switches to video during surplus; wherein surplus energy is more than 20 cd/m²; wherein the display shows weather alerts, public service announcements, and a counter of active distributed energy resources (“DERs”) in the state via Hedera blockchain; wherein a mobile app or Universal Serial Bus (“USB”)-connected device, with quantum key distribution (“QKD”)-encrypted offline mode, allows fleet planners to set priorities; wherein priorities include range, carbon credits, sell-back; wherein the mobile app or USB connected device can customize ad displays, enhancing adaptability for dynamic logistics; wherein a control unit using 0.1-0.5 kW; wherein the control unit updates content; wherein content includes state-specific ads, public service announcements, QR-coded Bills of Lading (“BOLs”); wherein content is updated upon crossing predefined geographic boundaries; wherein QR codes are 0.1-0.2 m²; wherein QR codes utilize 1-10 kB of bandwidth; wherein QR codes are cryptographically linked to a Hedera blockchain, activated only at designated locations for secure verification; and wherein the control unit adjusts ad display based on available power from Stirling or wind sources.

In another embodiment: a semi-truck and tractor-trailer power system comprising a semi-truck and tractor-trailer structure (53 ft, 200-400 m² surface area) with a carbon nanolattice skeleton (50-100 GPa) and 2DPA-1 encapsulation (0.5-2 mm, 3.5 GPa), forming a lightweight superstructure (986-2,634 kg/single, 1,972-5,268 kg/tandem) of 3D-printed modular components (170-200 modules, 5-15 kg each) for walls, ceiling, support posts, chassis, coupler plate, and cross-members/roof bows. In another embodiment: wherein the superstructure integrates structural supercapacitors (nitrogen-doped carbon nanolattice, 100-200 kWh) and PEDOT-based storage (500-1,000 kWh) in walls and ceiling, storing 600-1,200 kWh total, with 10-20% capacity increase via retrofits. In another embodiment: wherein piezoelectric elements include lead zirconate titanate (“PZT”) and Polyvinylidene fluoride (“PVDF”); wherein PZT and PCDF are between 0.1-0.5 mm; wherein PZT and PCDF harvest vibrational energy at 10-100 Hz at 15-50 kWh/day/semi-truck and tractor-trailer; and wherein harvesting this vibrational energy contributes to total output of 1,483.21-5,993.3 kWh/day from wind (892.8-3,621.15 kWh/day), mechanical (259-652 kWh/day), solar (300-500 kWh/day), and Stirling (334.8-1,710.88 kWh/day) sources. In another embodiment: wherein the superstructure reduces weight by 25-50% compared to aluminum semi-trucks and tractor-trailers (2,000-3,500 kg), decreasing energy consumption to 1.75-1.85 kWh/mile, increasing cargo capacity by 500-1,500 kg, and extending EV tractor range by 100-400 km/day/semi-truck and tractor-trailer (200-800 km/day/tandem) through integrated energy storage (600-1,200 kWh) and generation (1,483.21-5,993.3 kWh/day). enables rapid replacement (1-6 hours/module) and retrofits (10-20% storage increase, 600-1,200 kWh), reduces energy consumption to 1.75-1.85 kWh/mile, lifespan 10-15 years (abstract: 25 years) The modular and 3 D printable nature allow rapid system upgrades when new materials are available

In another embodiment: wherein 3D-printed components enable rapid replacement (1-6 hours/module) and support a lifespan of 10-15 years, positioning the semi-truck and tractor-trailer as a mobile energy node for grid resiliency. In another embodiment: wherein an AI-based BMS optimizes energy distribution across all sources and storage, enabling grid sell-back and carbon credits via Hedera blockchain. In another embodiment: wherein the structural skeleton comprises a 2DPA-1 polymer outer layer providing mechanical strength and a nitrogen-doped carbon nano-lattice inner layer serving as an active battery component, the layers connected via a tongue-and-groove interlock for precise alignment, and further comprising gold-plated, sealed electrical contacts for power and high-speed data transmission and m12 rated connection; wherein interlayer crosslinkers (epoxy/benzoxazine adhesives) Leveragee aerospace-grade film adhesives or UV-cure prepregs; wherein the crosslinkers are processed on existing composite presses/autoclaves at 100-200° C. and 1-5 MPa; wherein no new tooling is required; wherein cure cycles are industry-standard; and wherein bond-strength (>50 MPa) is more than sufficient for semi-truck and tractor-trailer cross-members. In another embodiment: A dedicated USB-enabled device with an integrated LCD screen can be used as a centralized control and display interface for the entire energy and systems management of the semi-truck and tractor-trailer. This device would not only connect to the EV Semi CANbus but also interface with the energy storage system, solar systems, AC/DC power sources, AI-based monitoring systems, and even manage EMF monitoring and carbon credit offsets for energy sellback purposes.

In another embodiment: further comprising a USB-driven battery management system (BMS) device (0.1-0.5 kg, 0.01-0.02 kWh/day) embedded in the semi-truck and tractor-trailer, interfacing with a Controller Area Network (“CAN”) bus (International Organization for Standards (“ISO”) 11898, 250-500 kilobits per second (“kbps”)) to collect real-time data (0.1-0.5 Megabyte (“MB”)/s) from wind axial flux generators (892.8-3,621.15 kWh/day), multilayer solar films (200-400 kWh/day), and 3D-printed structural supercapacitors (10-50 kWh, 0.1-0.5 kWh/kg), wherein the BMS employs edge-computing AI artificial neural network (“ANN”)/forming limit curve (“FLC”) algorithms, 0.1-0.5 MB Random access memory (“RAM”), 95-98% fault prediction accuracy) to monitor electrical system performance, optimize power flow (5-10% efficiency gain, 54.64-401.12 kWh/day savings), and detect anomalies (0.1-1 ms response), and interfaces with a solid-state transformer (SST, 0.5-1 m³, 50-100 kg, 98-99% efficiency) to convert DC to AC for grid sell-back of excess energy (500-2,000 kWh/day for semi-trucks and tractor-trailers), utilizing Hedera Token Service (“HTS”) on the Guardian framework (0.0001 killoWatt-hour per transaction (“kWh/tx”)) to tokenize energy transactions (kWh) and renewable energy certificates (“RECs”), (1 MWh=1 REC, for semi-trucks and tractor-trailers) recorded on a carbon-negative blockchain (10-50 metric tons of Carbon Dioxide equivalent (“tCO₂e”)/semi-truck and tractor-trailer/year offset, per year/semi-truck and tractor-trailer), enabling carbon credit trading (Certified Emission Reductions, 1 tCO₂e/credit) and offsets for scope 2 emissions, scalable to a tandem configuration (two semi-trucks and tractor-trailers, 1,000-4,000 kWh/day sell-back, 20-100 tCO₂e/year offset).

In another embodiment: A Stirling heat recovery system for a semi-truck and tractor-trailer platform, comprising a free-piston micro-Stirling engine (5-10 kg) integrated with wind axial flux generators (892.8-3,621.15 kWh/day, 2 cylinders) and mechanically driven generators (259-652 kWh/day, 2 cylinders), mounted with 4 cylinders total (2 on the back of the semi-truck and tractor-trailer, 2 on the underside of the semi-truck and tractor-trailer), converting waste heat from the generator cylinders into electrical energy at 334.8-1,710.88 kWh/day per semi-truck and tractor-trailer (669.6-3,421.76 kWh/day per tandem). A Stirling heat recovery system . . . converting waste heat into electrical energy, adaptable for semi-truck and tractor-trailer, spaceflight, or residential applications with future optimization. In another embodiment: wherein the Stirling engine is a beta-type configuration with generator cylinders internally cooled by lanthanum-iron-silicon (LaFeSi) magnetocaloric material (2-25 kg, 1-5 kW cooling power, 100-500 W/kg) to boost efficiency by 5-10%, adding 67-190 kWh/day per semi-truck and tractor-trailer, and integrates repelling magnets (0.1-0.5 kg each) to create a pulse-boost effect adding 2-3% efficiency (6.7-51.3 kWh/day), photonic sensors (e.g., laser-based, <0.1 kg, 1 μm resolution, 10 kHz sampling) to monitor piston position and speed for optimal repulsion timing, spintronic actuators (0.1-0.5 nm graphene, <0.05 kg) to dynamically modulate magnetic fields (0.1-1 T), and spintronic layers (0.1-0.5 nm graphene, <0.1 kg) in generator stators to enhance electrical output by 2-5%, adding 44.64-181.06 kWh/day per semi-truck and tractor-trailer. In another embodiment: wherein an AI-based BMS optimizes power distribution by disengaging solar inputs (300-500 kWh/day) or mechanical axial flux inputs (259-652 kWh/day) when hybrid energy storage (600-1,200 kWh, 500-1,000 kWh PEDOT, 100-200 kWh supercapacitors) is full, redirecting Stirling power to the EV semi for immediate use (300-1,200 kWh/day, supporting 500-1,000 km/day at 0.3-0.6 kWh/km) or saving it for use closer to the destination, enabling grid sell-back of excess energy (1,083.21-5,193.3 kWh/day per semi-truck and tractor-trailer) per year for 10 tandems) via Hedera blockchain, enhancing carbon credits by 20-50% and supporting EV range (585.97-1,750.42 km/day per semi-truck and tractor-trailer). In another embodiment: wherein the AI-based BMS dynamically switches to different power sources based on destination proximity, prioritizing Stirling power (334.8-1,710.88 kWh/day) to directly power the EV semi via CANbus integration (300-1,200 kWh/day, supporting 500-1,000 km/day at 0.3-0.6 kWh/km) when storage is full, disengaging other sources like solar (300-500 kWh/day) or wind axial flux (892.8-3,621.15 kWh/day) to maximize power production and revenue, ensuring optimal energy utilization as a mobile energy node.

In another embodiment: wherein the AI-based BMS provides on-the-fly prioritization of all external power sources—wind axial flux (892.8-3,621.15 kWh/day), mechanical (259-652 kWh/day), solar (300-500 kWh/day), and Stirling (334.8-1,710.88 kWh/day)—using real-time control to maximize energy production, utilizing these sources fully before tapping into the main EV semi battery, thereby extending the operating range (585.97-1,750.42 km/day per semi-truck and tractor-trailer). In another embodiment: wherein a mobile app integrates with the AI-based BMS and CANbus to actively control power distribution, adjusting priorities based on route, weather, and destination conditions, offering user customization and automation to optimize the multi-source energy system (wind, mechanical, solar, Stirling) for maximum power production (1,483.21-5,993.3 kWh/day) and offering grid sell-back). In another embodiment: wherein a USB LCD device (0.1-0.5 kg, 0.01-0.02 kWh/day) interfaces with the CANbus (ISO 11898, 250-500 kbps) to collect real-time data (0.1-0.5 MB/s) from wind axial flux generators, solar films, Stirling engines, and SSTs, employing edge-computing AI (ANN/FLC, 0.1-0.5 MB RAM, 95-98% fault prediction) to optimize power flow (5-10% efficiency gain, 54.64-401.12 kWh/day), detect anomalies (0.1-1 ms response), monitor EMF levels from REBCO-shielded components (<1 V/m), and manage grid sell-back (500-2,000 kWh/day) and carbon offsets (10-50 tCO₂e/semi-truck and tractor-trailer/year) via Hedera blockchain, accessible offline and via mobile app for user control. In another embodiment: wherein the USB LCD device, mobile app, and AI-based BMS interface with the Hedera blockchain to track energy production (1,483.21-5,993.3 kWh/day) and excess energy (1,083.21-5,193.3 kWh/day), calculate carbon offsets, and manage grid sell-back transactions, logging carbon credits with 20-50% enhancement, ensuring transparent monetization and reinforcing the semi-truck and tractor-trailer's role as a mobile energy node.

In another embodiment: wherein multiple beta-type Stirling modules (2-4 per semi-truck and tractor-trailer, 5-10 kg each) are arranged in series to capture different heat grades (e.g., 200° C. wind, 150° C. mechanical) or in parallel to cover hotspots across axial flux cylinders, each producing 83.7-427.72 kWh/day, improving overall efficiency by 1-2% (3.3-34.2 kWh/day), contributing to a total output of 408.14-2,133.24 kWh/day per semi-truck and tractor-trailer. In another embodiment: wherein the AI-based BMS uses photonic sensor data and spintronic feedback to dynamically adjust the timing and strength of magnetic repulsion (e.g., 0.1-1 Tesla at 30-70% expansion stroke), optimizing energy recovery in real-time based on varying heat inputs (535.7-2,172.87 kWh/day from wind, 155.2-521.6 kWh/day from mechanical), accessible via mobile app and USB LCD device for user adjustments.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

1. A modular Wind Axial Flux Method Generators (“WAFMG”) comprising:
an airflow intake system circular inlet within a tractor cab spoiler, capturing laminar airflow via Bernoulli's principle; and
wherein the laminar air flow is between 10 and 20 meters per second.

2. The system of claim 1, further comprising:
an inlet cone;
a converging duct that is 5.5 feet in length;
wherein the converging duct is behind the inlet cone;
the converging duct having a 0.5-1 m² inlet and incrementally decreasing to a 0.02-0.0667 m² outlet;
with a 3:1-5:1 ratio of converging duct that empties airflow onto an impeller; and
wherein the converging duct causes airflow to accelerate to 15-70 m/s.

3. The system of claim 1, further comprising:
an energy recovery device (“ERD”) converts airflow into a mechanical shaft rotation with high-efficiency blade geometry.

4. The system of claim 1, further comprising:
an axial flux generator system with 2-3 cylinders;
wherein each cylinder has 5 modular graphene-based axial flux generators;
wherein each modular graphene-based axial flux generator is 180-810 kilograms (“kg”) total;
wherein the 2-3 cylinders are mounted on a semi-truck and tractor-trailer's rear wall; and
wherein the 2-3 cylinders are co-joined by a central shaft acting as a power multiplier.

5. The system of claim 1, further comprising:
a vacuum-sealed polymer chamber: two dimensional polyarylene (“2DPA-1”) polymer at 0.22 atmosphere (“atm”) to reduce air resistance and enhance cooling.

6. The system of claim 1, further comprising:
Lanthanum Iron Silicon (“LaFeSi”) magnetocaloric cooling with graphene film;
wherein integrated cooling includes vacuum cooling, graphene cooling, and LaFeSi magnetocaloric cooling all at once;
wherein integrated cooling is 100-500 Watts (“W”)/kg;
wherein graphene-layered cylinder walls weigh 0.1-0.5 kg; and
wherein graphene-layered cylinder walls manage heat and boost efficiency.

7. The system of claim 1, further comprising:
spintronics and photonics integration, such that both spintronics and photonics are utilized at once;
wherein there are Graphene spintronic layers between 0.1-0.5 nm inside of casing in axial flux cylinder;
wherein there are photonic waveguides between 0.01-0.05 kg inside of casing in axial flux cylinder;
wherein the Graphene spintronic layers and photonic waveguides eliminate electromagnetic interference (“EMI”) and increases efficiency, respectively.

8. The system of claim 1, further comprising:
wherein passive magnetic bearings are on shaft and generators for higher rotations per minute (“RPM”), reducing friction and heat.

9. The system of claim 1, further comprising:
Stirling Waste Heat Recovery:
wherein 2-5 Stirling-type engines with LaFeSi cooling modification recover 1,339.2-5,431.725 kilowatt-hours (“kWh”)/day of waste heat per semi-truck and tractor-trailer, adding 334.8-1,710.88 kWh/day of power.

10. An energy generation system comprising:
a circular air intake vent within the tractor cab spoiler;
wherein the circular air intake captures laminar airflow at 10-20 m/s;
wherein an inlet cone and narrowing airflow duct with a fixed inlet protrusion accelerate air velocity to 15-70 m/s; and
wherein an ERD coupled to a central shaft converts airflow energy into mechanical rotational motion.

10. The system of claim 10, further comprising:
wherein the air intake is a circular inlet (5-inch diameter) transitioning into a venturi-shaped duct (0.5-1 m² inlet to 0.02-0.0667 m² outlet, 3:1-5:1 ratio), producing 892.8-3,621.15 kWh/day (2 cylinders) to 1,339.2-5,431.725 kWh/day (3 cylinders).

11. The system of claim 10, further comprising:
wherein the ERD uses high-efficiency blade geometry to convert airflow kinetic energy into shaft torque at 15-70 m/s (5% losses).

13. A generator system comprising:
wherein 2-3 cylinders, each with 5 modular graphene-based axial flux generators that weigh 180-810 kg total;
wherein each cylinder is mounted on a semi-truck and tractor-trailer's rear wall;
wherein there are Graphene/Carbon Nanotube (“CNT”) multilayer interleaved windings;
wherein each Graphene/CNT multilayer interleaved winding is 500-5,000 Sheets/m² for enhanced electrical conductivity;
wherein there is a vacuum-sealed cylindrical housing of 2DPA-1 polymer; and
wherein pressure inside the housing is 0.22 atm.

14. The generator of claim 13, further comprising:
wherein integrated LaFeSi magnetocaloric cooling at a rate of 100-500 W/kg;
wherein graphene-layered cylinder walls that weigh 0.1-0.5 kg each; and
wherein the cooling and walls reduce thermal losses and improve efficiency by 5-10%

15. The generator of claim 13, further comprising:
wherein spintronic components that are 0.1-0.5 nm graphene layers reduce electromagnetic interference, and boost efficiency of energy production by 2-5%

16. The generator of claim 13, further comprising:
wherein photonic waveguides that are 0.01-0.05 kg eliminate signal loss due to EMI, increasing efficiency by 1-2%

17. The energy recovery and axial flux generator system of claims 10-16,
wherein graphene or CNT windings increase electrical conductivity by 35% compared to copper, with lightweight 2DPA-1 rotors coated with NbN—CO thin films to manage magnetic fields, synergizing with LaFeSi cooling.

18. The system of claims 10-16,
wherein the vacuum-sealed chamber at 0.22 atm enhances heat dissipation and power efficiency via a vacuum pump.

19. The system of claims 10-16,
wherein passive magnetic bearings on the central shaft and modular generators increase RPM, reducing friction and heat.

20. The system of claims 10-16,
wherein the wind axial flux generators produce 892.8-3,621.15 kWh/day (2 cylinders) to 1,339.2-5,431.725 kWh/day (3 cylinders) at 20-42% efficiency, scalable for single (1,000-1,500 kg) or tandem (2,000-3,000 kg) configurations with additional cylinders on subsequent semi-trucks and tractor-trailers.

21. The system of claims 10-16,
wherein 2-5 Stirling-type engines with integrated LaFeSi magnetocaloric cooling (1-5 kW each, 12-125 kg total, 25-35% efficiency with 5-10% boost) recover 1,339.2-5,431.725 kWh/day of waste heat per semi-truck and tractor-trailer, adding 334.8-1,710.88 kWh/day.

22. The system of claims 10-16,
wherein an artificial intelligence (“AI”)-driven energy management system optimizes power distribution between wind axial flux generators, solar films (300-500 kWh/day), Stirling (334.8-1,710.88 kWh/day), and hybrid storage (500-1,000 kWh), enabling grid sell-back via Hedera smart contracts.

23. The system of claims 10-16,
wherein three dimensional (“3D”)-printable upgrades (1-2 weeks) ensure lightweight integration (total semi-truck and tractor-trailer weight 986-2,634 kg, tandem 1,972-5,268 kg), positioning semi-trucks and tractor-trailers as mobile energy nodes.

24. Smart Energy Management: An artificial intelligence (“AI”)-driven energy management system to optimize power distribution between axial flux generators, supercapacitors, hybrid Poly(3,4-ethylenedioxythiophene) (“PEDOT”) energy storage, and solar/wind inputs, structural supercapacitors and Solid State Transformers (“SST”) enhancing efficiency.

25. Magnetic bearings on shaft and generators for higher RPM; 2-5 Stirling-type engines with LaFeSi cooling recover 1,339.2-5,431.725 kWh/day of waste heat, adding 334.8-1,710.88 kWh/day.

26. A semi-truck and tractor-trailer power system comprising:
pressure plates (0.1-0.5 m2, 0.1-0.3 kg) capturing axle inertia (10-20 Hz, 0.1-0.5 Nm torque);
Enhanced Ratio Drive Converter (“ERDC”) impellers (0.3-0.5 m diameter, 6-12 carbon fiber blades, 0.5-1 kg) driven at 100-500 RPM; and
an ERD torque boost mechanism coupled to a central shaft, converting mechanical energy into rotational motion.

27. The system of claim 26, further comprising:
wherein the ERD includes planetary gears (2:1-5:1 ratio, 0.3-0.5 kg) amplifying torque by 20-50% (0.24-1.5 Nm/cylinder), driving a Kevlar belt (1-2 m, 0.1-0.2 kg) and carbon fiber shaft (1-2 kg), producing 259-652 kWh/day.

28. The system of claim 26, further comprising:
wherein a clutch/actuator engages the ERD at 100-500 RPM and disengages when idle, optimizing efficiency (0-0.05% loss) in terms of energy loss per semi-truck and tractor-trailer.

29. A generator system, comprising:
two vacuum-sealed cylindrical housings, each having an internal pressure of 0.22 atm, a diameter of 0.35-0.45 m, a length of 0.4-0.5 m, and a mass of 5-10 kg;
four modular axial-flux generators housed in each cylindrical housing, for a total of eight modular axial-flux generators;
2DPA-1 polymer rotors and yokes, each rotor or yoke having a mass of 0.05-0.1 kg and a Young's modulus of 10-20 Gigapascals (“GPa”);
niobium-nitride-carbon-monoxide (NbN—CO) thin-film coatings on each rotor and yoke;
wherein the coatings have a thickness of 1-10 nm;
wherein the coatings have 1-5 stacked layers;
wherein total coated surface area is 0.1-0.5 m²; and
wherein the coatings channel 30-50 percent of magnetic flux that would be provided by steel, corresponding to a magnetic flux density in the range of 0.45-1 Tesla (“T”).

30. The generator of claim 29, further comprising:
wherein graphene/CNT interleaved windings (0.01-0.1 kg, 50-500 S/m) increase output by 20-42% (4.15-17.93 kW/unit), achieving 259-652 kWh/day at 536-1,733 RPM.

31. The generator of claim 29, further comprising:
wherein integrated LaFeSi magnetocaloric cooling (0.1-0.5 kg, 4-20 K) and graphene films (0.5-2 m²/cylinder, 0.0001-0.001 kg/m²) reduce thermal losses by 10-20% (0.166-1.912 kWh per semi-truck and tractor-trailer).

32. The generator of claim 29, further comprising:
wherein passive magnetic bearings reduce friction by 0.1-0.5%;
wherein spintronic layers (0.1-0.5 nm) with photonic waveguides (0.01-0.05 kg) eliminate EMI;
and wherein this results in boosting efficiency in energy production by 1-5%.

33. The energy recovery and axial flux generator system of claims 26-32, wherein the system achieves 33-45% more efficiency in energy production;
wherein the system produces 259-652 kWh/day; and
wherein NbN—CO coatings synergize with LaFeSi cooling.

34. The system of claims 26-32, further comprising:
wherein a vacuum-sealed chamber has a pressure of 0.22 atm;
wherein the vacuum-sealed chamber enhances heat dissipation and power efficiency via a vacuum pump.

35. The system of claims 26-32, further comprising:
wherein an Al-driven energy management system optimizes power distribution between mechanical generators (259-652 kWh/day), wind axial flux (892.8-3,621.15 kWh/day), solar films (300-500 kWh/day), Stirling (334.8-1,710.88 kWh/day), and hybrid storage (500-1,000 kWh), enabling grid sell-back via Hedera smart contracts.

36. The system of claims 26-32, further comprising:
wherein 3D-printable upgrades take 1-2 weeks;
wherein 3D-printable upgrades ensure lightweight integration;
wherein total semi-truck and tractor-trailer weight is 986-2,634 kg;
wherein tandem weight is 1,972-5,268 kg; and
wherein the 3D-printable upgrades enhance fuel efficiency.

37. The system of claims 26-32, further comprising:
wherein 2-5 Stirling-type engines with integrated LaFeSi cooling (1-5 kW each, 12-125 kg total, 25-35% efficiency with 5-10% boost) recover 1,339.2-5,431.725 kWh/day of waste heat from mechanical and wind generators, adding 334.8-1,710.88 kWh/day.

38. A top encapsulation & protective layer for a semi-truck and tractor-trailer, comprising:
a transparent 2DPA-1 polymeric layer;
wherein the polymeric layer weighs between 0.5-1 kg;
wherein the polymeric layer has an anti-reflective, nanostructured dichroic surface that reduces heat;
wherein reduction of heat is between 10-20%; and
wherein the polymeric layer enhances light trapping for underlying photovoltaic layers.

39. An optical enhancement or textured light-trapping layer (layer 2) for a semi-truck and tractor-trailer:
wherein a Perovskite layer absorbs a broad spectrum of light;
wherein the Perovskite layer increases 15-25% efficiency of power production;
wherein the Perovskite layer is enhanced by Quantum Dots;
wherein the Quantum Dots provide a 5-10% low-light boost;
wherein the low-light boost yields 300-500 kWh/day across 200-400 m² of Perovskite layer.

40. Dynamic electroluminescent (“EL”) and quantum dot layers:
wherein EL emits light;
wherein the EL and quantum dot layers are tuned by Quantum Dots;
wherein the Quantum Dots weigh 0.5-1 kg total;
wherein the Quantum Dots enable a dynamic billboard for geo-fenced advertising, public service announcements, and quick response (“QR”)-coded bill of lading;
wherein density of the Quantum Dots is 0.1-0.2 m²;
wherein 1-10 kB encoding shipment data includes Identification, origin, destination and weight;
wherein the EL and quantum dot layers are integrated with a Quantum Key Distribution (“QKD”)-encrypted iOS/Android app; and
wherein there is Hedera blockchain for ad scheduling, logistics management and carbon credit tracking.

41. A transparent conductive electrode(s):
Wherein graphene or silver nanowire networks weigh between 0.1-0.5 kg;
Wherein graphene or silver nanowire networks provide electrical connections for display; and
wherein graphene or silver nanowire networks transmit light to photovoltaic layers.

42. A Perovskite photovoltaic active layer:
wherein the perovskite layer acts as the primary light-absorbing and energy-converting medium;
wherein the perovskite layer is optimized for high conversion efficiency and broad spectral response; and
wherein the perovskite layer benefits from enhanced light-trapping effects imparted by a textured layer above the perovskite layer.

43. Maximum power point tracking (“MPPT”)/Printed Electronics Layer and Back Electrode:
a printed electronics layer with Field effect transistors (“FET”) and MPPT circuitry;
wherein the printed electronics layer weighs between 0.5-1 kg;
wherein the printed electronics layer optimizes power extraction;
wherein the power extraction sees a 5-10% efficiency gain; and
wherein the printed electronics layer includes a back electrode reflecting unabsorbed light into a Perovskite layer.

44. Solid State Transformers (SSTs):
an integrated energy conditioning and storage system for a semi-truck and tractor-trailer platform, comprising:
Solid-state transformers (“SSTs”) mounted in upper corners of the semi-truck and tractor-trailer;
wherein the SSTs weigh 5-10 kg total;
wherein the SSTs condition power from wind axial flux generators resulting in 892.8-3,621.15 kWh/day;
wherein the SSTs condition power from mechanical axial flux generators resulting in 259-652 kWh/day;
wherein the SSTs condition power from photovoltaic films resulting in 300-500 kWh/day;
wherein the SSTs condition power from Stirling waste heat recovery resulting in 334.8-1,710.88 kWh/day;
wherein a hybrid energy storage system is embedded in the semi-truck and tractor-trailer's walls and ceiling;
wherein the hybrid energy storage system weighs 5-15 kg,
wherein the hybrid energy storage system comprises PEDOT and polystyrene sulfonate and graphene oxide (“PEDOT:PSS:Gox”) films and electrochemical cells;
wherein the electrochemical cells are greater than 200 Wh/kg;
wherein the electrochemical cells have between 500-1,000 kWh capacity;
wherein the hybrid energy storage system is integrated with 2DPA-1 structural supercapacitors (100-200 kWh); and
wherein an AI-based battery management system (“BMS”) optimizes power flow, supporting grid sell-back via Hedera smart contracts.

45. The system of claim 44, further comprising:
flexible hybrid energy storage modules,
wherein the SSTs incorporate spintronic switching elements and photonic control circuitry, improving alternating current-direct current (“AC-DC”) conversion and inversion efficiency by 10-15%.

46. The system of claim 44, further comprising:
an energy management and control system:
wherein the SSTs provide voltage isolation and conditioning for onboard loads, including dynamic billboard content management and power beaming for docking operations.

47. A hybrid energy storage system embedded in the 2DPAF-1 structure's floorboards, walls, and ceiling, comprising a conductive polymer matrix (e.g., PEDOT) and one or more electrochemical cells or equivalent energy storage devices;
wherein the electrochemical cells or equivalent energy storage devices can be selected from any combination of batteries, supercapacitors, fuel cells, solid-state, lithium-iron-phosphate, sodium-ion, and hybrid configurations with energy density greater than 200 Wh/kg or equivalent performance;
wherein the electrochemical cells or equivalent energy storage device is configured to store energy from the wind axial flux generators, mechanical axial flux generators, and photovoltaic cells; and
wherein a battery management system supporting fast-charging (e.g., ≥4 C), low-temperature operation (e.g., −30° C. charging), and high cycle life (e.g., ≥2,000 cycles);

48. The system of claim 47, further comprising:
wherein PEDOT:PSS:Gox films are produced via solution-based deposition; and
wherein the PEDOT:PSS:Gox films enhance structural integrity alongside 2DPA-1 structural supercapacitors.

49. The system of claim 47, further comprising:
wherein sidewalls and ceiling and floorboards of a semi-truck and tractor-trailer incorporate PEDOT:PSS with embedded thin solid state batteries (“SSBs”);
wherein the SSBs are 20-40 kWh and 200-400 Wh/kg;
wherein the SSBs provide structural energy storage and electromagnetic field (“EMF”) shielding via high temperature superconductor (“HTS”) rare earth Barium copper oxide (“Rebco”) wrapping, managed by SSTs and AI BMS to extend EV range by 50-100 km/day; and
distinct from conventional EV battery packs through multi-functional structural integration.

50. The system of claim 47, further comprising:
wherein the AI-based BMS implements MPPT algorithms to optimize energy harvest from solar films and other sources, ensuring efficient distribution across all onboard systems.

51. The system of claim 47, further comprising:
wherein the hybrid storage system supports a total capacity of 500-1,000 kWh, storing energy from all generation sources for grid resiliency.

52. The system of claim 47, further comprising:
wherein the semi-truck and tractor-trailer's produces a total energy output of 1,483.21-5,993.3 kWh/day;
wherein the semi-truck and tractor-trailer's energy production allows it to act as a mobile energy node for logistics and grid support.

53. The system of claim 47, further comprising:
wherein 3D-printable upgrades (1-2 weeks) ensure lightweight integration (total semi-truck and tractor-trailer weight 986-2,634 kg, tandem 1,972-5,268 kg).

54. The system of claim 47, further comprising:
wherein the AI-based BMS enables carbon credit offsets via Hedera blockchain integration.

55. The system of claim 47, further comprising:
wherein sidewalls and ceiling, floorboards incorporate PEDOT:PSS with embedded thin SSBs, providing 10-20 kWh structural energy storage, wrapped with HTS REBCO for EMF shielding and heat reflection, managed by SSTs and AI BMS.

56. A dynamic content management system for a semi-truck and tractor-trailer platform, comprising:
a dynamic display integrated into the semi-truck and tractor-trailer's exterior (10-20 m²) using EL/Quantum Dot films, capable of updating visual content in real-time;
a geo-fencing module (GPS-based, 0.01-0.1 kW) detecting the semi-truck and tractor-trailer's location within a 1-10 km radius;
wherein a control unit uses 0.1-0.5 kW;
wherein the control unit updates content;
wherein content includes state-specific ads, public service announcements, QR-coded Bills of Lading (“BOLs”);
wherein content is updated upon crossing predefined geographic boundaries;
wherein QR codes are 0.1-0.2 m²;
wherein QR codes utilize 1-10 kB of bandwidth;
wherein QR codes are cryptographically linked to a Hedera blockchain, activated only at designated locations for secure verification; and
wherein the control unit adjusts ad display based on available power from Stirling or wind sources.

57. The system of claim 56,
wherein a dynamic content management system (“CMS”) electronic (“EL”) display is integrated with a multi-source energy congregation system, comprising axial flux wind generators (892.8-3,621.15 kWh/day), solar films (200-400 kWh/day), and Stirling heat recovery (421.48-2,218.79 kWh/day), managed by a Solid State Transformer (SST, 98-99% efficiency) and an AI BMS to optimize power flow to an electric vehicle (“EV”) semi battery and display;
wherein the display adjusts content in real-time based on route data and energy forecasts, switching to text-only ads during low energy;
wherein low energy is 20 cd/m² or less;
wherein the display switches to video during surplus;
wherein surplus energy is more than 20 cd/m²;
wherein the display shows weather alerts, public service announcements, and a counter of active distributed energy resources (“DERs”) in the state via Hedera blockchain;
wherein a mobile app or Universal Serial Bus (“USB”)-connected device, with quantum key distribution (“QKD”)-encrypted offline mode, allows fleet planners to set priorities;
wherein priorities include range, carbon credits, sell-back;
wherein the mobile app or USB connected device can customize ad displays, enhancing adaptability for dynamic logistics;
wherein a control unit using 0.1-0.5 kW;
wherein the control unit updates content;
wherein content includes state-specific ads, public service announcements, QR-coded Bills of Lading (“BOLs”);
wherein content is updated upon crossing predefined geographic boundaries;
wherein QR codes are 0.1-0.2 m²;
wherein QR codes utilize 1-10 kB of bandwidth;
wherein QR codes are cryptographically linked to a Hedera blockchain, activated only at designated locations for secure verification; and
wherein the control unit adjusts ad display based on available power from Stirling or wind sources.

58. The system of claim 56,
wherein the control unit updates content every 1-10 minutes at state boundaries or checkpoints;
wherein the control unit utilizes geo-targeted advertising.

59. The system of claim 56,
wherein QR codes remain inactive during transit, activating only at predefined locations;
wherein predefined locations include ports of origin;
preventing unauthorized access to sensitive BOL data (shipment ID, origin, destination, weight)

60. The system of claim 56,
wherein a QKD-encrypted iOS/Android app with Hedera blockchain integration displays geo-fenced advertisements on semi-truck and tractor-trailer screens based on location data;
wherein the AI-based BMS and SSTs dynamically adjust ad display by switching to text-only ads when power falls below a threshold, varying brightness based on SST-managed energy availability, external light levels, rural encounter rates, and route-based real-time optimization using energy forecasts;
wherein energy forecasts include predictions of solar and wind conditions;
wherein the AI-based BMS displays weather warnings or public service announcements when imminent issues are detected;
wherein fleet managers can set priorities including energy savings for carbon credits, sell-back, or range, via the mobile app;
wherein a user can override priorities via USB LCD device or mobile app, and transactions are logged on Hedera blockchain;
wherein an EL display optimizes content in real-time based on route data and SST-managed energy forecasts, enabling fleet managers to prioritize energy strategies with weather and PSA integration;
wherein fleet managers can set route-specific energy priorities managed by SSTs and override or customize ad displays via USB LCD device or mobile app, with transactions logged on Hedera blockchain;
wherein, with transactions logged on Hedera blockchain, and displaying real-time information as a distributed energy resource, including number of active DER semi-truck and tractor-trailers in a state, updated via EL displays and integrated external API;
wherein users are able to define trip-specific parameters, including energy savings, revenue focus, via the mobile interface, enhancing adaptability for dynamic logistics managed by SSTs;
wherein transactions are logged on Hedera blockchain, adaptable for a semi-truck and tractor-trailer and potential aviation applications with future optimization.

61. The system of claim 56,
wherein the dynamic display consumes 10-20 kWh/day, powered by solar films (300-500 kWh/day) and hybrid storage (500-1,000 kWh), with minimal aerodynamic impact (<1% drag increase, 0.001-0.002 kWh/km), and includes an adaptive operation mode that schedules downtime (e.g., 4-6 hours/day in rural areas or early morning hours) to reduce power usage to 5-15 kWh/day, conserving resources while maintaining advertising functionality.

62. The system of claim 56,
wherein the control unit interfaces with supply chain systems to integrate secure digital BOLs and shipment tracking, enabling dual functionality for advertising and logistics.

63. Embedded industrial controllers are used to run the dynamic content application, geo-fencing algorithms, and Hedera integration software (via appropriate SDKs). These units handle data from GPS and connectivity modules, process location-based triggers, and update the display accordingly since the system integrates with Hedera to tie QR codes and digital documents to a secure ledger, a secure cryptographic module is utilized like QKD This ensures that all cryptographic keys and transactions (such as QR code validations) are handled in a tamper-resistant manner, complying with security standards for blockchain interactions. System on a chip (Soc) Integrates cellular connectivity (LTE/5G) to retrieve remote updates and securely interface with the Hedera network. A secure HSM installed on the embedded controller to cryptographically via QKD tie dynamic QR codes to digital documents (such as a digital Bill of Lading or state specific advertisements).

64. The system of claim 63,
wherein an AI-based BMS optimizes power allocation for the dynamic display wherein the semi-truck and tractor-trailer's total output (1,483.21-5,993.3 kWh/day) and geo-fenced advertising reinforce its role as a mobile energy node, supporting grid sell-back and carbon credits via Hedera blockchain. The system of claim 1, wherein an AI-based BMS optimizes power allocation for the dynamic display, ensuring integration with wind (892.8-3,621.15 kWh/day), mechanical (259-652 kWh/day), solar (300-500 kWh/day), and Stirling (334.8-1,710.88 kWh/day), Displays the number many distributed active energy resources available at any time on the semi-truck and tractor-trailer system via Hedera.

65. A semi-truck and tractor-trailer power system comprising a semi-truck and tractor-trailer structure (53 ft, 200-400 m² surface area) with a carbon nanolattice skeleton (50-100 GPa) and 2DPA-1 encapsulation (0.5-2 mm, 3.5 GPa), forming a lightweight superstructure (986-2,634 kg/single, 1,972-5,268 kg/tandem) of 3D-printed modular components (170-200 modules, 5-15 kg each) for walls, ceiling, support posts, chassis, coupler plate, and cross-members/roof bows.

66. The system of claim 65,
wherein the superstructure integrates structural supercapacitors (nitrogen-doped carbon nanolattice, 100-200 kWh) and PEDOT-based storage (500-1,000 kWh) in walls and ceiling, storing 600-1,200 kWh total, with 10-20% capacity increase via retrofits.

67. The system of claim 65,
wherein piezoelectric elements include lead zirconate titanate (“PZT”) and Polyvinylidene fluoride (“PVDF”);
wherein PZT and PCDF are between 0.1-0.5 mm;
wherein PZT and PCDF harvest vibrational energy at 10-100 Hz at 15-50 kWh/day/semi-truck and tractor-trailer; and
wherein harvesting this vibrational energy contributes to total output of 1,483.21-5,993.3 kWh/day from wind (892.8-3,621.15 kWh/day), mechanical (259-652 kWh/day), solar (300-500 kWh/day), and Stirling (334.8-1,710.88 kWh/day) sources.

68. The system of claim 65,
wherein the superstructure reduces weight by 25-50% compared to aluminum semi-trucks and tractor-trailers (2,000-3,500 kg), decreasing energy consumption to 1.75-1.85 kWh/mile, increasing cargo capacity by 500-1,500 kg, and extending EV tractor range by 100-400 km/day/semi-truck and tractor-trailer (200-800 km/day/tandem) through integrated energy storage (600-1,200 kWh) and generation (1,483.21-5,993.3 kWh/day). enables rapid replacement (1-6 hours/module) and retrofits (10-20% storage increase, 600-1,200 kWh), reduces energy consumption to 1.75-1.85 kWh/mile, lifespan 10-15 years (abstract: 25 years) The modular and 3D printable nature allow rapid system upgrades when new materials are available

69. The system of claim 65,
wherein 3D-printed components enable rapid replacement (1-6 hours/module) and support a lifespan of 10-15 years, positioning the semi-truck and tractor-trailer as a mobile energy node for grid resiliency.

70. The system of claim 65,
wherein an Al-based BMS optimizes energy distribution across all sources and storage, enabling grid sell-back and carbon credits via Hedera blockchain.

71. The system of claim 65,
wherein the structural skeleton comprises a 2DPA-1 polymer outer layer providing mechanical strength and a nitrogen-doped carbon nano-lattice inner layer serving as an active battery component, the layers connected via a tongue-and-groove interlock for precise alignment, and further comprising gold-plated, sealed electrical contacts for power and high-speed data transmission and m12 rated connection;
wherein interlayer crosslinkers (epoxy/benzoxazine adhesives) Leveragee aerospace-grade film adhesives or UV-cure prepregs;
wherein the crosslinkers are processed on existing composite presses/autoclaves at 100-200° C. and 1-5 MPa;
wherein no new tooling is required;
wherein cure cycles are industry-standard; and
wherein bond-strength (>50 MPa) is more than sufficient for semi-truck and tractor-trailer cross-members.

72. A dedicated USB-enabled device with an integrated LCD screen can be used as a centralized control and display interface for the entire energy and systems management of the semi-truck and tractor-trailer. This device would not only connect to the EV Semi CANbus but also interface with the energy storage system, solar systems, AC/DC power sources, AI-based monitoring systems, and even manage EMF monitoring and carbon credit offsets for energy sellback purposes.

73. The system of claim 72,
further comprising a USB-driven battery management system (BMS) device (0.1-0.5 kg, 0.01-0.02 kWh/day) embedded in the semi-truck and tractor-trailer, interfacing with a Controller Area Network (“CAN”) bus (International Organization for Standards (“ISO”) 11898, 250-500 kilobits per second (“kbps”)) to collect real-time data (0.1-0.5 Megabyte (“MB”)/s) from wind axial flux generators (892.8-3,621.15 kWh/day), multilayer solar films (200-400 kWh/day), and 3D-printed structural supercapacitors (10-50 kWh, 0.1-0.5 kWh/kg), wherein the BMS employs edge-computing AI artificial neural network (“ANN”)/forming limit curve (“FLC”) algorithms, 0.1-0.5 MB Random access memory (“RAM”), 95-98% fault prediction accuracy) to monitor electrical system performance, optimize power flow (5-10% efficiency gain, 54.64-401.12 kWh/day savings), and detect anomalies (0.1-1 ms response), and interfaces with a solid-state transformer (SST, 0.5-1 m³, 50-100 kg, 98-99% efficiency) to convert DC to AC for grid sell-back of excess energy (500-2,000 kWh/day for semi-trucks and tractor-trailers), utilizing Hedera Token Service (“HTS”) on the Guardian framework (0.0001 killoWatt-hour per transaction (“kWh/tx”)) to tokenize energy transactions (kWh) and renewable energy certificates (“RECs”), (1 MWh=1 REC, for semi-trucks and tractor-trailers) recorded on a carbon-negative blockchain (10-50 metric tons of Carbon Dioxide equivalent (“tCO₂e”)/semi-truck and tractor-trailer/year offset, per year/semi-truck and tractor-trailer), enabling carbon credit trading (Certified Emission Reductions, 1 tCO₂e/credit) and offsets for scope 2 emissions, scalable to a tandem configuration (two semi-trucks and tractor-trailers, 1,000-4,000 kWh/day sell-back, 20-100 tCO₂e/year offset).

74. A Stirling heat recovery system for a semi-truck and tractor-trailer platform, comprising a free-piston micro-Stirling engine (5-10 kg) integrated with wind axial flux generators (892.8-3,621.15 kWh/day, 2 cylinders) and mechanically driven generators (259-652 kWh/day, 2 cylinders), mounted with 4 cylinders total (2 on the back of the semi-truck and tractor-trailer, 2 on the underside of the semi-truck and tractor-trailer), converting waste heat from the generator cylinders into electrical energy at 334.8-1,710.88 kWh/day per semi-truck and tractor-trailer (669.6-3,421.76 kWh/day per tandem). A Stirling heat recovery system . . . converting waste heat into electrical energy, adaptable for semi-truck and tractor-trailer, spaceflight, or residential applications with future optimization.

75. The system of claim 74,
wherein the Stirling engine is a beta-type configuration with generator cylinders internally cooled by lanthanum-iron-silicon (LaFeSi) magnetocaloric material (2-25 kg, 1-5 kW cooling power, 100-500 W/kg) to boost efficiency by 5-10%, adding 67-190 kWh/day per semi-truck and tractor-trailer, and integrates repelling magnets (0.1-0.5 kg each) to create a pulse-boost effect adding 2-3% efficiency (6.7-51.3 kWh/day), photonic sensors (e.g., laser-based, <0.1 kg, 1 μm resolution, 10 kHz sampling) to monitor piston position and speed for optimal repulsion timing, spintronic actuators (0.1-0.5 nm graphene, <0.05 kg) to dynamically modulate magnetic fields (0.1-1 T), and spintronic layers (0.1-0.5 nm graphene, <0.1 kg) in generator stators to enhance electrical output by 2-5%, adding 44.64-181.06 kWh/day per semi-truck and tractor-trailer.

76. The system of claim 74,
wherein an AI-based BMS optimizes power distribution by disengaging solar inputs (300-500 kWh/day) or mechanical axial flux inputs (259-652 kWh/day) when hybrid energy storage (600-1,200 kWh, 500-1,000 kWh PEDOT, 100-200 kWh supercapacitors) is full, redirecting Stirling power to the EV semi for immediate use (300-1,200 kWh/day, supporting 500-1,000 km/day at 0.3-0.6 kWh/km) or saving it for use closer to the destination, enabling grid sell-back of excess energy (1,083.21-5,193.3 kWh/day per semi-truck and tractor-trailer) per year for 10 tandems) via Hedera blockchain, enhancing carbon credits by 20-50% and supporting EV range (585.97-1,750.42 km/day per semi-truck and tractor-trailer).

77. The system of claim 74,
wherein the AI-based BMS dynamically switches to different power sources based on destination proximity, prioritizing Stirling power (334.8-1,710.88 kWh/day) to directly power the EV semi via CANbus integration (300-1,200 kWh/day, supporting 500-1,000 km/day at 0.3-0.6 kWh/km) when storage is full, disengaging other sources like solar (300-500 kWh/day) or wind axial flux (892.8-3,621.15 kWh/day) to maximize power production and revenue, ensuring optimal energy utilization as a mobile energy node.

78. The system of claim 74,
wherein the AI-based BMS provides on-the-fly prioritization of all external power sources—wind axial flux (892.8-3,621.15 kWh/day), mechanical (259-652 kWh/day), solar (300-500 kWh/day), and Stirling (334.8-1,710.88 kWh/day)—using real-time control to maximize energy production, utilizing these sources fully before tapping into the main EV semi battery, thereby extending the operating range (585.97-1,750.42 km/day per semi-truck and tractor-trailer).

79. the system of claim 74,
wherein a mobile app integrates with the AI-based BMS and CANbus to actively control power distribution, adjusting priorities based on route, weather, and destination conditions, offering user customization and automation to optimize the multi-source energy system (wind, mechanical, solar, Stirling) for maximum power production (1,483.21-5,993.3 kWh/day) and offering grid sell-back).

80. The system of claim 74,
wherein a USB LCD device (0.1-0.5 kg, 0.01-0.02 kWh/day) interfaces with the CANbus (ISO 11898, 250-500 kbps) to collect real-time data (0.1-0.5 MB/s) from wind axial flux generators, solar films, Stirling engines, and SSTs, employing edge-computing AI (ANN/FLC, 0.1-0.5 MB RAM, 95-98% fault prediction) to optimize power flow (5-10% efficiency gain, 54.64-401.12 kWh/day), detect anomalies (0.1-1 ms response), monitor EMF levels from REBCO-shielded components (<1 V/m), and manage grid sell-back (500-2,000 kWh/day) and carbon offsets (10-50 tCO₂e/semi-truck and tractor-trailer/year) via Hedera blockchain, accessible offline and via mobile app for user control.

81. The system of claim 74,
wherein the USB LCD device, mobile app, and AI-based BMS interface with the Hedera blockchain to track energy production (1,483.21-5,993.3 kWh/day) and excess energy (1,083.21-5,193.3 kWh/day), calculate carbon offsets, and manage grid sell-back transactions, logging carbon credits with 20-50% enhancement, ensuring transparent monetization and reinforcing the semi-truck and tractor-trailer's role as a mobile energy node.

82. The system of claim 74,
wherein multiple beta-type Stirling modules (2-4 per semi-truck and tractor-trailer, 5-10 kg each) are arranged in series to capture different heat grades (e.g., 200° C. wind, 150° C. mechanical) or in parallel to cover hotspots across axial flux cylinders, each producing 83.7-427.72 kWh/day, improving overall efficiency by 1-2% (3.3-34.2 kWh/day), contributing to a total output of 408.14-2,133.24 kWh/day per semi-truck and tractor-trailer.

83. The system of claim 74,
wherein the AI-based BMS uses photonic sensor data and spintronic feedback to dynamically adjust the timing and strength of magnetic repulsion (e.g., 0.1-1 Tesla at 30-70% expansion stroke), optimizing energy recovery in real-time based on varying heat inputs (535.7-2,172.87 kWh/day from wind, 155.2-521.6 kWh/day from mechanical), accessible via mobile app and USB LCD device for user adjustments.
